(19) United States
(12) Patent Application Publication
(10) Pub. No.: US 2025/0113282 A1
(43) Pub. Date: Apr. 3, 2025

(54) Enhanced AI/ML Based Mobility Optimization

(71) Applicant: QUALCOMM Incorporated, San Diego, CA (US)

(72) Inventors: Geetha Priya Rajendran, Bangalore (IN); Rajeev Kumar, San Diego, CA (US)

(21) Appl. No.: 18/478,879

(22) Filed: Sep. 29, 2023

(51) Int. Cl. H04W 36/36; H04B 17/391; H04W 76/27

(52) U.S. Cl. CPC H04W 36/365; H04B 17/3913; H04W 76/27

(57) ABSTRACT

Certain aspects of the present disclosure provide techniques for techniques for machine learning (ML)-based user equipment (UE) mobility. A method generally includes transmitting a handover request associated with handing over a UE from a first cell associated with an apparatus to a second cell associated with a first target network node, the handover request comprising an identifier (ID) of the apparatus and predicted information associated with the UE, the predicted information generated by a ML model; and receiving an information update message comprising: feedback information comprising feedback on the predicted information, the feedback information associated with refining the ML model, and a first persistent ID assigned to the UE, wherein the first persistent ID remains invariant across different radio resource control (RRC) modes of the UE, wherein the different RRC modes comprise an idle mode, an inactive mode, and a connected mode.

### BACKGROUND

### Field of the Disclosure

Aspects of the present disclosure relate to wireless communications, and more particularly, to techniques for machine learning (ML)-based user equipment (UE) mobility.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Mobility, also commonly referred to as “handover,” is a process of transferring an ongoing communication session of a user equipment (UE) from a source cell to a target cell while in a connected mode (also referred to as a “connected state,” “radio resource control (RRC) connected mode,” and/or “RRC connected state”). UE mobility performance is important in cellular networks to help ensure quality of service (QoS) requirements for UEs are met, including meeting throughput, delay, and packet loss requirements defined for these UEs. There are known handover solutions which aid in providing seamless connectivity and uninterrupted service delivery for UEs to help meet such requirements. Some solutions involve the use of machine learning (ML) techniques to help optimize UE mobility operations.

For example, an ML model may be deployed at or on a predicting node (e.g., a predicting network entity) to generate prediction(s) and/or recommendation(s) for a specific UE during one or more handover procedures (e.g., as the UE moves from one cell to a next cell). Performance and accuracy of predictions generated by the ML model may be based on the amount and type of input data used to train the ML model. This input data may include feedback information for the UE collected from multiple handover operations, as well as across multiple RRC modes or states of the UE (e.g., a connected mode, an idle mode (also referred to as an “idle state,” “RRC idle mode,” and/or “RRC idle state”), and an inactive mode (also referred to as an “inactive state,” “RRC inactive mode,” and/or “RRC inactive state”)). As used herein, an idle mode of the UE refers to an RRC mode of the UE where the UE is not connected, or in other words, does not have an established RRC connection with a network node. Further, an inactive mode of the UE refers to an RRC mode of the UE where the UE has an established RRC connection with a network node, but the connection is in a dormant, suspended, or inactive state, where state information of the RRC connection is maintained at the UE and the network node, but there is not active communication between the UE and the network node. For example, while operating in the inactive mode, unlike the idle mode, a non-access stratum (NAS) layer of the RRC connection established by the UE may continue to be connected. Such feedback information for a UE may not always be accessible, however. In particular, in a radio access network (RAN) architecture, a UE may only be identifiable while in a connected mode. Thus, if the UE transitions from a connected mode to an idle or inactive mode, then feedback information related to that UE may no longer be provided to, and thus may no longer be available to a predicting node. Feedback information for a UE, may also be limited to a single hop of the UE (e.g., a single target node to which the UE hands over or whose coverage area the UE traverses). Due to the mobile nature of UEs, however, the UEs may undergo multiple handover procedures, especially in dense network areas having many cells, and feedback information for these additional handover procedures may not be available to the predicting node.

Accordingly, aspects described herein provide signaling mechanisms that enable each target node to which a UE is connected, either as a result of a handover procedure and/or as a result of the UE re-establishing or resuming an RRC connection with the target node (e.g., after being in an idle or inactive mode), to provide feedback information for the UE to a predicting node. For example, a UE transitioning from an RRC idle mode to an RRC connected mode may be referred to as the UE re-establishing or establishing an RRC connection. Further, a UE transitioning from an RRC inactive mode to an RRC connected mode may be referred to as the UE resuming an RRC connection.

One aspect provides a method for wireless communications by an apparatus at a source network node. The method includes transmitting a handover request associated with handing over a UE from a first cell associated with an apparatus to a second cell associated with a first target network node, the handover request comprising an identifier (ID) of the apparatus and predicted information associated with the UE, the predicted information generated by a ML model; and receiving an information update message comprising: feedback information comprising feedback on the predicted information, the feedback information associated with refining the ML model, and a first persistent ID assigned to the UE, wherein the first persistent ID remains invariant across different RRC modes of the UE, wherein the different RRC modes comprise an idle mode, an inactive mode, and a connected mode.

Another aspect provides a method for wireless communications by an apparatus at a first target network node. The method includes receiving a handover request associated with handing over a UE to a cell associated with the apparatus, the handover request comprising an ID of a source network node and predicted information associated with the UE, the predicted information generated by a ML model; and transmitting, to the source network node, an information update message comprising: feedback information comprising feedback on the predicted information, the feedback information used for refining the ML model, and a first persistent ID assigned to the UE, wherein the first persistent ID remains invariant across different RRC modes of the UE, wherein the different RRC modes comprise an idle mode, an inactive mode, and a connected mode.

Another aspect provides a method for wireless communications by an apparatus at a first target network node. The method includes receiving a RRC connection request requesting to re-establish or resume an RRC connection with a UE, the RRC connection request comprising an ID of a source network node configured to use a ML model to generate predicted information for the UE; re-establishing or resuming the RRC connection with the UE in response to receiving the RRC connection request; and transmitting, to the source network node, an information update message comprising: feedback information comprising feedback on the predicted information, the feedback information associated with refining the ML model, and a first persistent ID assigned to the UE, wherein the first persistent ID remains invariant across different RRC modes of the UE, wherein the different RRC modes comprise an idle mode, an inactive mode, and a connected mode.

Another aspect provides a method for wireless communications by an apparatus at a UE. The method includes receiving, from a first target network node communicating with the apparatus, an RRC release message indicating that the apparatus is to transition from a connected mode to an idle mode or an inactive mode, the RRC release message comprising an ID of a source network node configured to generate predicted information for the apparatus via a ML model; transitioning from the connected mode to the inactive mode or the idle mode in response to receiving the RRC release message; and transmitting, to a second target network node, an RRC connection request requesting to re-establish or resume an RRC connection with the second target network node, the RRC connection request comprising the ID of the source network node.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 is a diagram illustrating an example architecture of a functional framework for radio access network (RAN) intelligence enabled by data collection.

FIG. 6 depicts a process flow for communications in a network between network entities, such as a source node and a target node, and UE that are used to support machine learning (ML)-based UE mobility.

FIG. 7A depicts a process flow for communications in a network between network entities, such as a source node and two predicted target nodes, and an access and mobility management function (AMF) that are used to support machine learning (ML)-based UE mobility.

FIG. 7B depicts another process flow for communications in a network between network entities, such as a source node and two predicted target nodes, and an AMF that are used to support ML-based UE mobility.

FIG. 8 depicts another process flow for communications in a network between network entities, such as a source node, a predicted target node, and an unpredicted target node, and an AMF that are used to support ML-based UE mobility.

FIG. 9 depicts another process flow for communications in a network between network entities, such as a source node, a predicted target node, and an unpredicted target node, a UE, and an AMF that are used to support ML-based UE mobility.

FIG. 10 depicts another process flow for communications in a network between network entities, such as a source node, a predicted target node, and an unpredicted target node, a UE, and an AMF that are used to support ML-based UE mobility.

FIG. 11A depicts another process flow for communications in a network between network entities, such as a source node and two predicted target nodes, a UE, and an AMF that are used to support ML-based UE mobility.

FIG. 11B depicts another process flow for communications in a network between network entities, such as a source node, a predicted target node, and an unpredicted target node, a UE, and an AMF that are used to support ML-based UE mobility.

FIG. 12 depicts a method for wireless communications. FIG. 13 depicts another method for wireless communications.

FIG. 14 depicts another method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for machine learning (ML)-based user equipment (UE) mobility. UE mobility, also referred to as “UE handover,” is a process that involves transferring a UE from a source cell associated with a source node (e.g., a source network entity) to a target cell associated with a target node (e.g., a target network entity), while in a connected mode (e.g., radio resource control (RRC) connected mode). For example, based on one or more measurements (e.g., channel measurements and/or device measurements) determined for a communications channel between a UE and the source node, the source node may decide to switch the UE's connection from the source cell to the target cell (e.g., due to better channel conditions).

UE mobility performance across cells is important in cellular networks to allow UEs to move freely, as well as access different resources and/or services without losing connectivity and/or decreasing quality of service (QoS) for the UE (e.g., decreasing throughput, increasing delay, increasing packet loss, etc.). One solution that aids in improving UE mobility performance includes the use of artificial intelligence (AI). More specifically, machine learning (ML) techniques may be used to support the generation of one or more predictions and/or recommendations used to help optimize handover procedures for a UE.

In some aspects, an ML model is deployed at or on a predicting node (e.g., a predicting network entity) to generate prediction(s) and/or recommendation(s) for a specific UE during one or more handover procedures (e.g., as the UE moves from one cell to a next cell). In some aspects, the predicting node may be the source node to which the UE is connected. Performance and accuracy of predictions generated by the ML model may be based on the amount and type of input data used to train the model. Specifically, to achieve acceptable model performance (e.g., above a performance threshold, a minimized loss function, etc.), a large amount of data for the specific UE may be collected and used as input data in the model to train and re-train the model until an acceptable model performance level is achieved. This input data may include feedback information for the UE collected from multiple handover operations, as well as across multiple RRC modes of the UE (e.g., a connected mode, an idle mode, and an inactive mode).

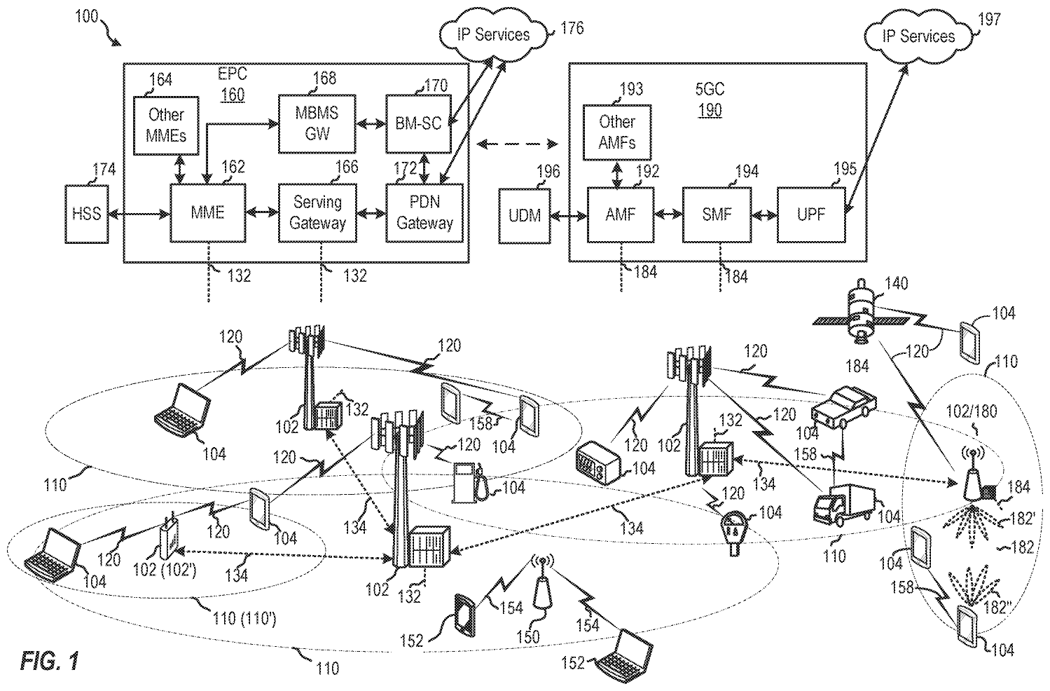

Such feedback information for a UE may not always be accessible, however. In particular, in a radio access network (RAN) architecture (e.g., such as wireless communications network 100 in FIG. 1), a UE may only be identifiable while within a connected mode. Thus, if the UE transitions from a connected mode to an idle or inactive mode, then feedback information related to that UE may no longer be provided to, and thus may longer be available to a predicting node (e.g., using the ML model to generate UE mobility prediction(s) and/or recommendation(s)).

Additionally, if a UE is handed over from a source node to a target node, then feedback information related to that UE may no longer be accessible to a predicting node (e.g., where the source node is the predicting node) subsequent to the handover. In other words, feedback information for a UE, may be limited to a single hop of the UE (e.g., a single target node to which the UE hands over or whose coverage area the UE traverses). Due to the mobile nature of UEs, however, multiple handover procedures may be needed, especially in dense network areas having many cells.

Accordingly, aspects described herein provide signaling mechanisms that enable each target node to which a UE is connected, either as a result of a handover procedure and/or as a result of the UE re-establishing or resuming an RRC connection with the target node (e.g., after being in an idle or inactive mode), to provide feedback information for the UE to a predicting node. As such, the predicting node may have sufficient information for the UE to be able to refine an ML model used by the predicting node to generate one or more mobility predictions and/or recommendations for the UE. Re-training the ML model based on real-time feedback from one or more target nodes connected to the UE (e.g., each connected to the UE at a single point in time) may improve overall performance of the ML model. More specifically, re-training the ML model helps to improve the overall accuracy of the model over time, and thus produce more accurate prediction(s) and/or recommendation(s) for UE mobility.

The signaling mechanisms described herein may involve, at least, providing a target node to which the UE is connected (e.g., after handover and/or after RRC re-establishment or resume) with an identifier (ID) of a predicting node configured to generate ML-based mobility predictions and recommendations for the UE. Providing the ID of the predicting node (e.g., an ID of the source node) to the target node informs the target node that ML feedback information is presently being collected for the UE, as well as informs the target node of the node, as in the predicting node, where feedback information for the UE should be sent. As such, continuous feedback information may be accessible to the predicting node.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects (also referred to herein as non-terrestrial network entities), such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

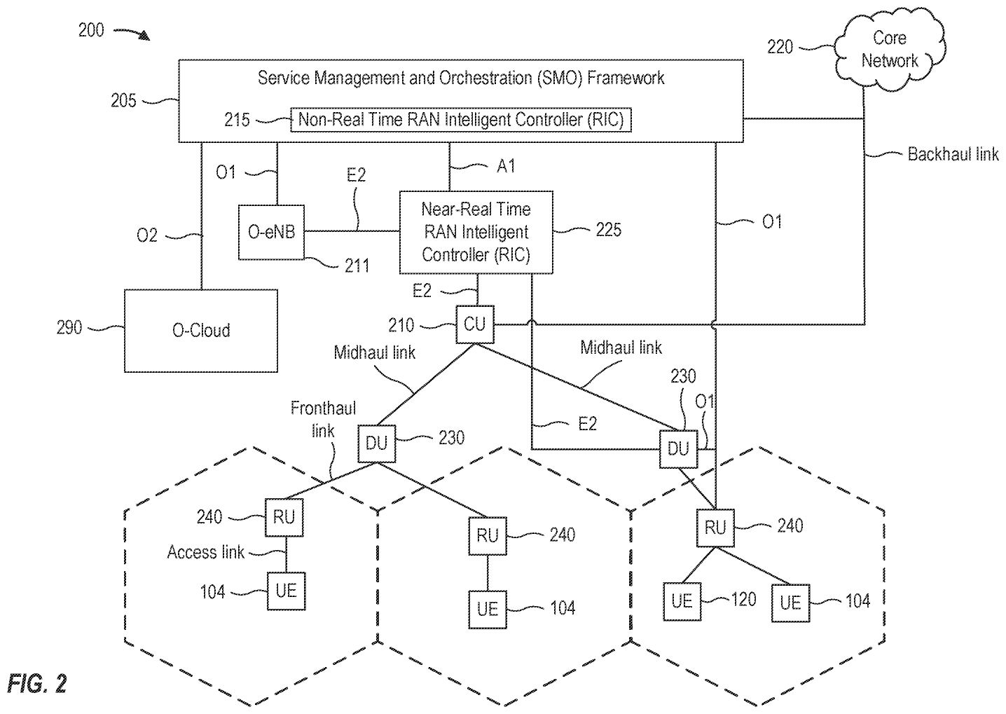

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

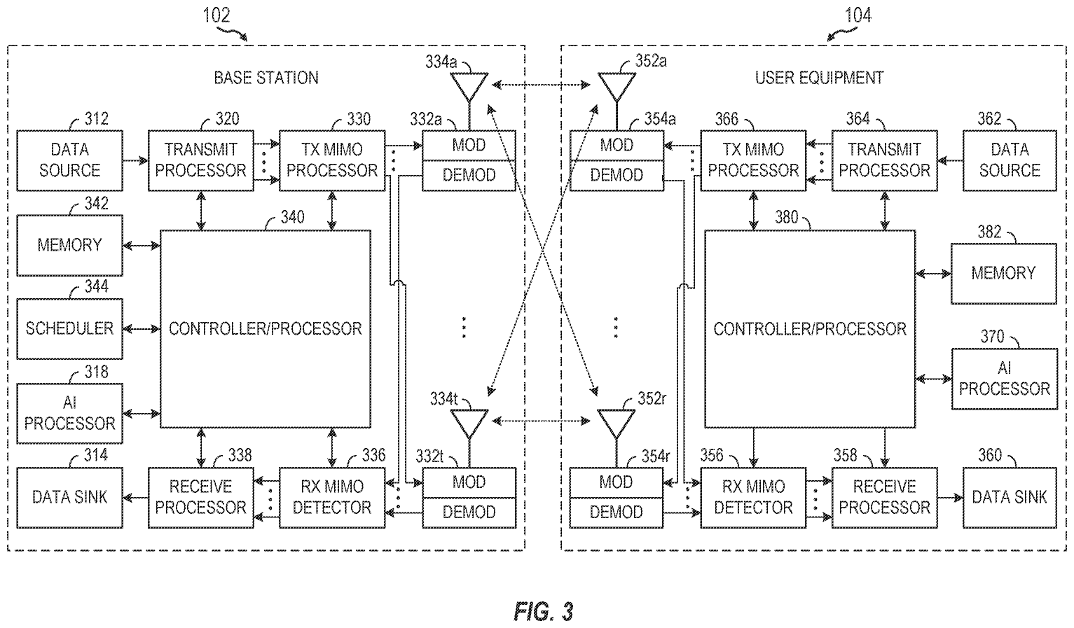

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

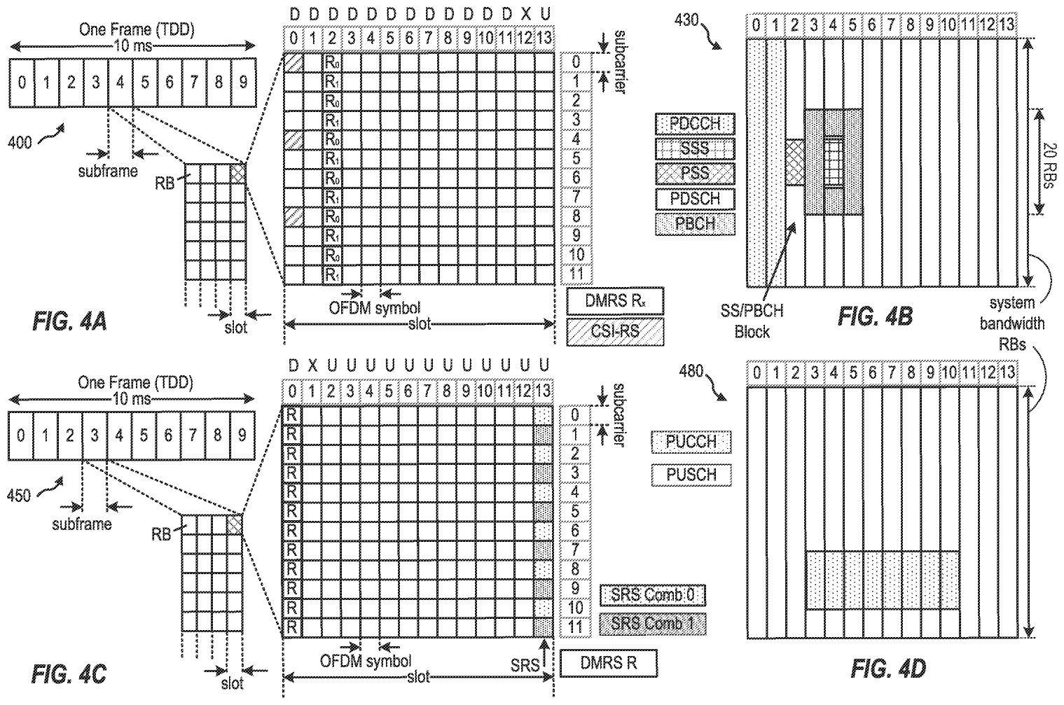

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to ML-Based UE Mobility

Mobility, also commonly referred to as “handover,” is a process of transferring an ongoing communication session of a UE (e.g., such as UE 104 in FIGS. 1-3) from a source cell to a target cell while in a connected mode (also referred to as a “connected state,” “radio resource control (RRC) connected mode,” and/or “RRC connected state”). While in a connected mode, the UE is connected to a network and radio resources are allocated to the UE.

One of the motivations behind handover procedures is to assist in the seamless connectivity and continuity of service for a UE, especially while the UE is mobile. For example, when a UE is being operated in a moving vehicle (or is a component of a moving vehicle), the UE may transition from communicating in a first cell (e.g., a source cell) in a first location to communicating in a second cell (e.g., a target cell) in a second location. A UE communicating with, communicating in, and/or being connected to a cell may refer to the UE being connected to a network entity (also referred to herein as a “network node” or “node”) and communicating with the network entity in a particular frequency range. A network entity may provide coverage in more than one cell, such as where the network entity communicates with UEs in different frequency ranges. Accordingly, a UE transferring from a source cell to a target cell may refer to the UE transferring from communicating with a first network entity in a first frequency range, to communicating with the first network entity in a second frequency range (e.g., intra-network entity (e.g., intra-BS) handover). As another example, a UE transferring from a source cell to a target cell may refer to the UE transferring from communicating with a first network entity in a first frequency range, to communicating with a second network entity in the first frequency range or a second frequency range (e.g., inter-network entity (e.g., inter-BS) handover).

New Radio (NR) supports different types of handover, including handover procedures where the network entity controls UE mobility based on UE measurement reporting. For example, in this procedure, a source network entity (e.g., a BS) associated with a source cell of a UE, may trigger a handover for the UE by transmitting a handover request to a target network entity associated with a target cell (e.g., inter-network entity handover). After receiving an acknowledgement (ACK) from the target network entity, the source network entity initiates the handover of the UE from the source cell to the target cell (e.g., from the source network entity to the target network entity) by transmitting a handover command with target cell configuration to the target network entity. The UE then accesses the target cell after the target cell configuration is applied.

UE mobility performance is critical in cellular networks to help ensure quality of service (QoS) requirements for UEs are met, including meeting throughput, delay, and packet loss requirements defined for these UEs. Multiple handover solutions which aid in providing seamless connectivity and uninterrupted service delivery for UEs have been proposed to help meet such requirements.

One solution involves the use of artificial intelligence (AI), and more specifically, machine learning (ML) techniques to help optimize UE mobility operations. For example, one or more ML models may be deployed at a network entity (e.g., associated with a source node) to perform determinations and/or generate predictions that may be used to improve one or more handover procedures for a UE. ML, a subdivision of AI, refers to training computer algorithms to make predictions based on experience. ML is an efficient tool that may be used to help reduce the complexity involved in (1) cell discovery (e.g., selecting a cell for a handover based on some criteria), (2) handover initiation determination (e.g., determining when the handover should take place), and (3) handover execution for achieving QoS with a suitable value (e.g., satisfies a threshold, achieves maximum QoS, etc.). In particular, ML may be used to help ensure that a UE is handed over to a suitable cell (e.g., based on some criteria), such as a cell that meets a quality requirement (e.g., channel quality indictor (CQI), reference signal received power (RSRP), etc.), as well as aid in the timely execution of handover such that radio link failures are minimized, while also avoiding unnecessary handovers. Further, ML may help to reduce the overhead associated with handover management without sacrificing system performance.

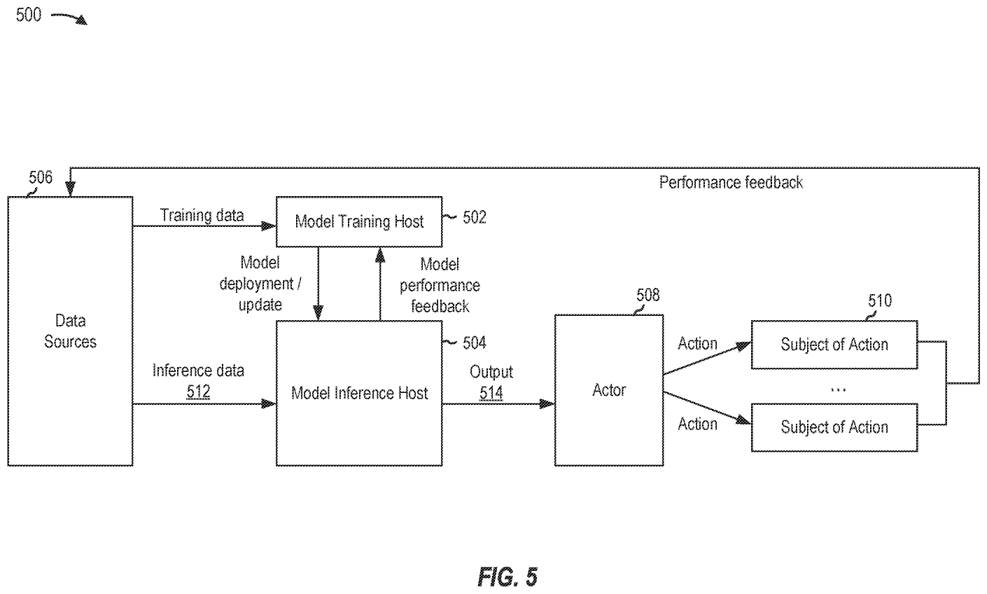

FIG. 5 is a diagram illustrating an example architecture 500 of a functional framework for radio access network (RAN) intelligence enabled by data collection. As illustrated, architecture 500 includes multiple logical entities, such as a model training host 502, a model inference host 504, data sources 506, and an actor 508. RAN intelligence enabled by ML and the associated functional framework may be utilized in various use cases, such as beam management, energy saving, load balancing, mobility management, and/or coverage optimization, among other examples. One or more benefits may be realized through the use of ML enabled RAN in such use cases.

Model inference host 504, in architecture 500, is configured to run an ML model based on inference data 512 provided by data sources 506. Model inference host 504 may produce an output 514 (e.g., a prediction) based on inference data 512, that is then provided as input into actor 508.

Actor 508 may be an element or an entity of a core network (CN) or a RAN. For example, actor 508 may be a UE (e.g., UE 104 in FIG. 1), a BS (e.g., a BS 102 in FIG. 1) or another network node (e.g., a gNB, a centralized unit (CU), a distributed unit (DU), and/or a radio unit (RU)), among other examples. Additionally, the type of actor 508 may also depend on the type of tasks performed by model inference host 504, the type of inference data 512 provided to model inference host 504, and/or the type of output 514 produced by model inference host 504.

For example, if output 514 from model inference host 504 is associated with beam management, then actor 508 may be a UE, a DU, or an RU. As another example, if output 514 from model inference host 504 is associated with transmission and/or reception scheduling, actor 508 may be a CU or a DU.

After actor 508 receives output 514 from model inference host 504, actor 508 may determine whether to act based on the output. For example, if actor 508 is a DU or an RU and the output from model inference host 504 is associated with beam management, actor 508 may determine whether to change/modify a transmission and/or a reception beam based on output 514. If actor 508 determines to act based on output 514, actor 508 may indicate the action to at least one subject of action 510. For example, if actor 508 determines to change/modify a transmission and/or reception beam for a communication between actor 508 and the subject of action 510 (e.g., a UE), then actor 508 may transmit a beam (re-)configuration or a beam switching indication to subject of action 510. Actor 508 may modify its transmission and/or reception beam based on the beam (re-)configuration, such as switching to a new transmission and/or reception beam and/or applying different parameters for a transmission and/or reception beam, among other examples. As another example, actor 508 may be a UE, and output 514 from model inference host 504 may be associated with beam management. For example, output 514 may be one or more predicted measurement values for one or more beams. Actor 508, the UE, may determine that a measurement report (e.g., a layer 1 (L1) reference signal received power (RSRP) report) is to be transmitted to a BS in communication with the UE. In some cases, actor 508 and subject of action 510 are the same entity.

Data sources 506 may be configured for collecting data that is used as training data 516 for training an ML model, or as inference data 512 for feeding an ML model inference operation. In particular, data sources 506 may collect data from one or more CN and/or RAN entities, which may include subject of action 510, and provide the collected data to a model training host 502 for ML model training. For example, after a subject of action 510 (e.g., a UE) receives a beam configuration from actor 508, subject of action 510 may provide performance feedback associated with the beam configuration to data sources 506, where the performance feedback may be used by the model training host 502 for monitoring and/or evaluating the ML model performance, such as whether output 514, provided to actor 508, is accurate. In some examples, if output 514 provided to actor 508 is inaccurate (or the accuracy is below an accuracy threshold), then model training host 502 may determine to modify or retrain the ML model used by model inference host 504, such as via an ML model deployment/update.

As described above, in some cases, an ML model is deployed at or on a network entity (e.g., such as BS 102 in FIG. 1) for purposes of generating ML-based predictions and recommendations for UE mobility. For example, an ML model configured to generate predicted information for one or more UEs (e.g., UEs that are subject to handover and/or have been involved in handover operation(s)) may be deployed at or on a predicting network entity. The predicting network entity (e.g., a source network entity associated with a source cell that a UE is connected to) may receive a set of measurements and execute the ML model, using the measurements, to predict, for example, a UE trajectory (e.g., a path along which the UE is predicted to travel) for the UE. The predicting network entity may use the predicted UE trajectory to help optimize one or more handover procedures, such as by predicting a target cell that the UE is to be handed over to. The target cell predicted by the predicting network entity may be a cell that enables the UE to maintain network coverage as the UE travels along the predicted trajectory path. In some other examples, a network entity (e.g., such as the predicting network entity) is configured to execute an ML model to predict traffic, performance measurements, such as latency, throughput, and/or the like, QoS, quality of experience (QoE), and/or the like for one or more UEs. Certain aspects are discussed herein with respect to a source network entity to which the UE is initially connected as the predicting network entity. However, it should be noted that another network entity may be the predicting network entity.

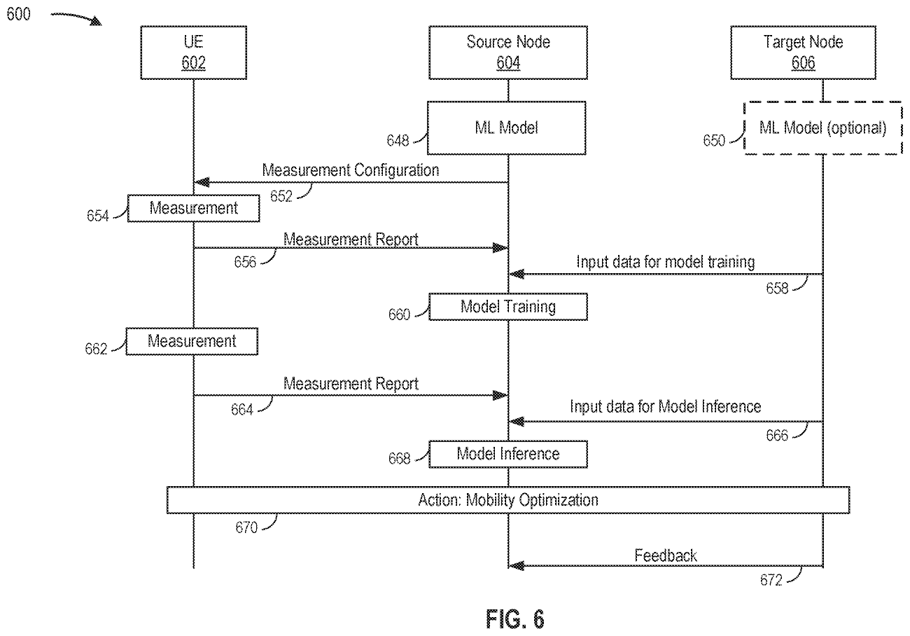

FIG. 6 depicts a process flow 600 for communications in a network between network entities, such as a source node 604 and a target node 606, and a UE 602 that are used to support ML-based UE mobility. In some aspects, source node 604 and target node 606 are each a network entity, which may be an example of BS 102 depicted and described with respect to FIGS. 1 and 3 or a disaggregated base station depicted and described with respect to FIG. 2. Further, in some aspects, source node 604 and target node 606 are each a next generation RAN (NG-RAN) node. Similarly, UE 602 may be an example of UE 104 depicted and described with respect to FIGS. 1 and 3. However, in other aspects, UE 104 may be another type of wireless communications device and source node 604 and/or target node 606 may be another type of network entity, such as those described herein.

As shown in FIG. 6 at 648, source node 604 may be configured with an AI/ML model, such as preconfigured, or as received from another network entity, such as a network controller. Additionally, as shown at 650, target node 606 may also, optionally, have an AI/ML model deployed at or on target node 606.

Process flow 600 begins, at step 652, by source node 604 configuring UE 602 to perform one or more measurements. For example, at step 652, source node 604 may transmit a measurement configuration message, such as via an information element (IE) of a control signaling message (e.g., RRC signaling, downlink control information (DCI) signaling, medium access control (MAC) control element (CE) (MAC-CE) signaling, and/or the like).

UE 602 may perform one or more measurements, at step 654, based on the configuration and transmit, at step 656, a measurement report identifying result(s) of the one or more measurements to source node 604. For example, at step 654, UE 602 may perform one or more channel measurements (e.g., channel quality measurement(s), channel congestion level measurement(s), and/or a signal strength measurement(s)) and/or one or more device measurements (e.g., UE transmit power level, UE battery power level, and/or the like), among other examples. UE 602 may report result(s) of these measurement(s) to source node 604 at step 656.

Process flow 600 proceeds, at step 658, with target node 606 transmitting input data for model training to source node 604. For example, target node 606 may transmit, at step 658, data identifying, for target node 606, a network congestion level, a set of UEs operating in a cell provided by target node 606, a set of beamforming parameters, a set of interference measurements, a set of channel characteristics, mobility data associated with other UEs, and/or mobility data associated with target node 606, among other examples.

Source node 604 uses the input data, received from target node 606 at step 658, and the measurement report, received from UE 602 at step 656, to train the ML model deployed at or on source node 604. In some aspects, source node 604 divides the input data into a training dataset and a validation dataset. Source node 604 may use the training dataset to adjust a set of model parameters to determine one or more weights for the set of model parameters. Further, source node 604 may use the validation dataset to validate the ML model with the determined weight(s).

After training the ML model, process flow 600 proceeds with using the trained model to make one or more predictions and/or recommendations, for example, with respect to UE 602 mobility optimization. In particular, process flow 600 proceeds, at steps 662 and 664, respectively, with UE 602 performing one or more new and/or additional measurements and transmitting another measurement report, identifying result(s) of the one or more measurements, to source node 604. Further, at step 668, target node 606 transmits new and/or additional input data to source node 604. For example, UE 602 may transmit, at step 664 to UE 602, a measurement report identifying a set of channel conditions or interference metrics associated with a channel. Additionally, or alternatively, target node 606 may transmit, at step 666 to source node 604, updated information, for target node 606, identifying a network congestion level, a set of UEs operating in a cell, a set of beamforming parameters, a set of interference measurements, a set of channel characteristics, mobility data, and/or the like.

Source node 604 uses the new and/or additional input data, received from target node 606 at step 666, and/or the new and/or additional measurement report, received from UE 602 at step 664, as input into the ML model deployed at or on source node 604. The ML model may process the input information and thereby generate a model inference at step 668. As an illustrative example, the model inference may be a predicted beamforming parameters and/or transmission configuration indicator (TCI) state (e.g., for transmitting signals) that UE 602 is to use for a handover from a current cell to a cell associated with target node 606. Beamforming is a technique used to improve the signal-to-noise ratio (SNR) of received signals, help to eliminate undesirable interference sources, and/or focus transmitted signals.

Process flow 600 proceeds, at step 670, with performing one or more actions based on the model inference generated at step 668. For the above example, UE 602 may be handed over to a cell of target node 606 using the predicted TCI state output by the ML model. More specifically, the predicted TCI state may be used to determine a beam that UE 602 is to use for communication with target node 606 during the handover.

Subsequent to completion of the handover procedure, process flow 600 proceeds, at step 672, with target node 606 providing feedback to source node 604. In some cases, target node 606 provides feedback to source node 604 based on a request from source node 604 requesting such feedback. The feedback may be related to predicted output generated by the ML model. For example, using the above example, the feedback may indicate whether a beam, selected based on the model predicted TCI state, during handover was successfully utilized by UE 602 for communication with target node 606.

As another illustrative example, the model inference generated at step 668 may be a predicted trajectory for UE 602 (e.g., a path along which UE 602 is predicted to travel). The predicted trajectory may be used to optimize one or more handover procedures for UE 602, such as by determining target node 606, as the target network node for which UE 602 is to be handed over to, to help ensure seamless connectivity and uninterrupted service delivery for UE 602 as UE 602 travels along the predicted path. Thus, at step 670, one or more actions may include making this determination and carrying out the handover of UE 602 to a cell associated with target node 606. In this case, source node 604 may request feedback on an actual trajectory of UE 602, and use this feedback information to adjust one or more weights and/or parameters of the ML model, such that a predicted UE trajectory more closely matches an actual UE trajectory over time (e.g., matches or almost matches with minimal acceptable error).

Enabling the transmittal of feedback from a target node (e.g., such as target node 606 in FIG. 6) to a predicting node (e.g., such as source node 604 in FIG. 6) using an ML model to make prediction(s) and/or recommendation(s) for UE mobility allows the ML-model to be re-trained based on such feedback. Re-training the ML model allows the model to become more accurate over time, and thus produce more accurate prediction(s) and/or recommendation(s) for UE mobility.

In some aspects, an ML model deployed at or on a predicting node is trained and deployed to generate prediction(s) and/or recommendation(s) for a specific UE (e.g., a UE-specific model). Another ML model deployed at or on the same predicting node may be trained and deployed to generate prediction(s) and/or recommendation(s) for another UE. To achieve acceptable model performance (e.g., above a performance threshold, etc.) for a UE-specific model, many iterations of re-training may be needed, thereby requiring continuous measurements and/or data for the specific UE. More specifically, to provide accurate model predictions, the UE-specific model may need to be trained on measurements and/or data collected for the UE across RRC modes. Examples of RRC modes include an RRC connected mode (also referred to as a “connected mode,” and introduced above), an RRC idle mode (also referred to as an “idle mode”), and an RRC inactive mode (also referred to as an “inactive mode”).

Unfortunately, however, feedback information for a UE may not always be accessible. In particular, in a RAN architecture (e.g., such as wireless communications network 100 in FIG. 1), a UE may only be identifiable while within a connected mode. Thus, if the UE transitions from a connected mode to an idle or inactive mode, then feedback information related to that UE may no longer be accessible. For example, UE power saving procedures may result in a UE, for example, going idle (e.g., transitioning to an idle mode) in a first cell and resuming a connection (e.g., transitioning to a connected mode) in a second cell. As a result of the transition from a connected mode to an idle or inactive mode, and back to a connected mode, feedback information for the UE may not be conveyed after the UE transitions back to the connected mode in the new cell. This presents a technical problem with using a ML model for UE mobility because feedback information for the UE may no longer be accessible after a UE makes a first transition to an idle and/or inactive node. While feedback information for the UE is available prior to the transition, while the UE is in the connected mode, a single connected session for a UE may last only a few minutes. The feedback information generated based on these few minutes of connection may not be sufficient feedback information for training the ML model to generate predictions and/or recommendations with respect to UE mobility.

Additionally, if a UE undergoes handover from a source node to a target node, then feedback information related to that UE may no longer be accessible subsequent to the handover. In other words, feedback information for a UE, provided to a predicting node for re-training an ML model, may be limited to a single hop of the UE (e.g., a single target node to which the UE hands over or whose coverage area the UE traverses). However, with increasingly dense deployments of cells, a UE may have a handover procedure that involves multiple hops (e.g., multiple actual and/or predicted target nodes to which the UE attempts to hand over). As a result, feedback information for the UE may be limited to feedback information collected for the UE prior to a first handover procedure involving the UE.

### Example Operations of Entities in a Communications Network

In order to overcome such technical problems associated with accessing feedback information for a UE, aspects described herein provide signaling mechanisms that enable a target node to transmit feedback information for a UE (1) after handover of the UE to a cell associated with the target node and/or (2) after a UE has re-established or resumed an RRC connection (e.g., after being in an idle or inactive mode). For example, in some aspects, the target node (e.g., in either scenario) is provided with an identifier (ID) of a predicting node configured to generate ML-based predictions and recommendations for mobility of the UE. Providing the predicting node ID to the target node informs the target node that ML feedback information is presently being collected for the UE. Further, a target node in possession of a predicting node ID may enable the target node to relay feedback information for the UE to the predicting node after handover and/or after the UE has transitioned between RRC modes (e.g., where the target node has been previously configured for AI/ML measurement and feedback). Alternatively, a target node in possession of a predicting node ID may enable the target node to communicate with the predicting node to inform the predicting node that the UE is connected to the target node (e.g., where the target node has not been previously configured to AI/ML measurement and feedback). In response, the predicting node may configure the target node to provide feedback information for the UE, where the feedback information is configured to refine an ML model deployed at or on the predicting node for generating ML-based UE mobility prediction(s) and/or recommendation(s).

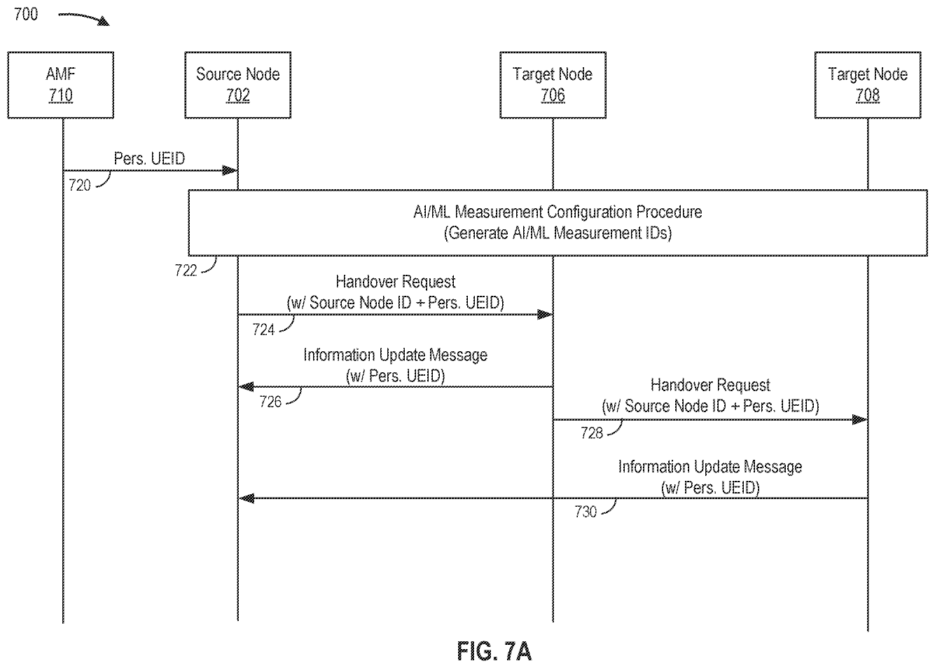

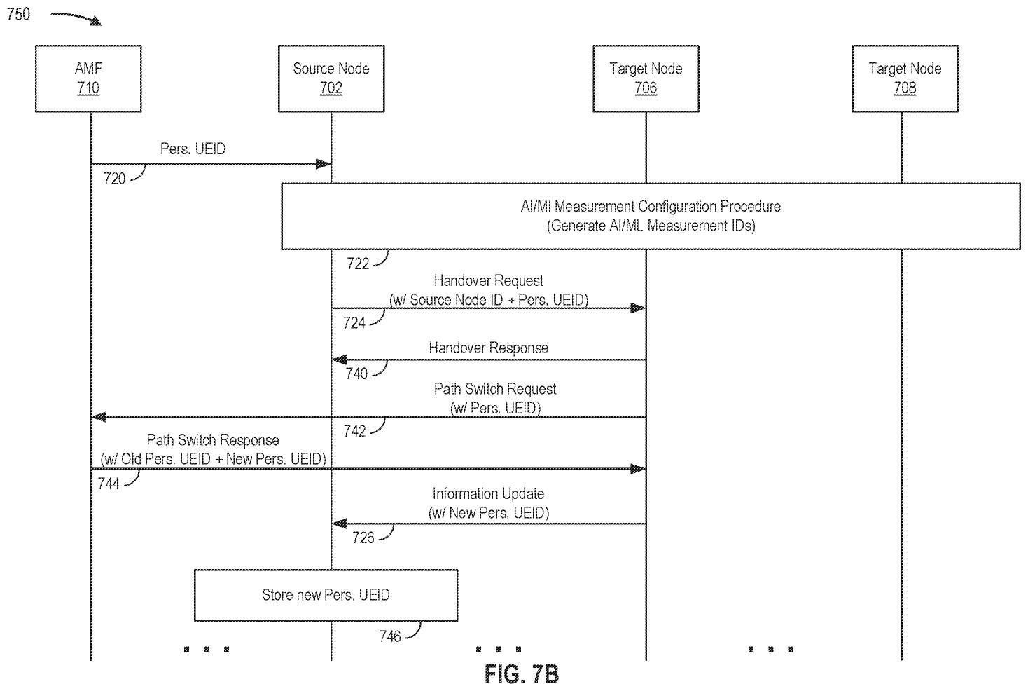

Different signaling mechanisms are described in detail below with respect to FIGS. 7A-11B.

FIG. 7A depicts a process flow 700 for communications in a network between network entities, such as a source node 702 and two predicted target nodes 706, 708 (simply referred to as “target node 706” and “target node 708,” and an access and mobility management function (AMF) 710 that are used to support ML-based UE mobility. In some aspects, source node 702, target node 706, and target node 708 are each a network entity, which may be an example of BS 102 depicted and described with respect to FIGS. 1 and 3 or a disaggregated base station depicted and described with respect to FIG. 2. However, in other aspects, source node 702, target node 706, and/or target node 708 each may be another type of network entity, such as those described herein. Further, in some aspects, source node 702, target node 706, and target node 708 are each an NG-RAN node.

Although FIG. 7A illustrates target node 706 and target node 708 as individual network nodes, in some other cases, target nodes 706 and 708 are distributed units (DUs) of a single network node, which may be a centralized unit (CU). For example, target nodes 706 and 708 may represent NG-RAN logical entities of a single NG-RAN node.

In FIG. 7A, source node 702 may be configured with an ML model for generating prediction(s) and/or recommendation(s) for mobility of a UE (not shown in FIG. 7A) (e.g., such as UE 104 in FIGS. 1 and 3). For example, source node 702 may have an ML model deployed at or on source node 702. Additionally, in some aspects (although not shown), target node 706 and/or target node 708 may also, optionally, have an ML model deployed thereon.

Process flow 700 illustrates a mobility scenario where a UE (not shown) is first handed over from a cell associated with source node 702 to a cell associated with target node 706, and then again handed over from the cell associated with target node 706 to a cell associated with target node 708. The signaling illustrated in FIG. 7A enables each of target node 706 and target node 708 to provide UE feedback information to source node 702, such that source node 702 is able to refine an ML model used by source node 702 to generate one or more predictions and/or recommendations regarding mobility of the UE.

Process flow 700 begins, at step 720, by AMF 710 providing, to source node 702, a persistent ID (“Pers. UEID”) of the UE that is subject to handover. The persistent ID of the UE is an ID that remains invariant across different radio resource control (RRC) modes of the UE, wherein the different RRC modes comprise an idle mode, an inactive mode, and a connected mode. As described below, the persistent UEID may be transferred between one or more entities in FIG. 7A. Target node 706 and target node 708 may include this persistent UEID when transmitting feedback information to source node 702, such that source node 702 is aware which UE (e.g., in case source node 702 is configured to generate prediction(s) and/or recommendation(s) for multiple UEs) the feedback information relates to such that the correct ML model can be refined based on this information.

Process flow 700 proceeds, at step 722, by source node 702, target node 706, and target node 708 performing an AI/ML measurement configuration procedure. For example, source node 702 may determine a predicted trajectory path for the UE subject to handover includes the UE being connected to (e.g., handed over to) target node 706 and target node 708. Based on this prediction, source node 702 may configure target node 706 and target node 708 to provide feedback information for the UE, when the UE is connected to each of these nodes respectively. Configuring target node 706 and target node 708 may include configuring target node 706 and target node 708 with one or more measurement IDs (also referred to as AI/ML measurement IDs), where each of the one or more measurement IDs are associated with measurement information relating to the ML model. For example, a first measurement ID may be associated with a UE trajectory determination (e.g., not a predicted trajectory), a second measurement ID may be associated with a UE traffic determination, a third measurement ID may be associated with a QoS determination for the UE, a fourth measurement ID may be associated with a QoE determination for the UE, etc. In particular, a measurement ID indicates a type of measurement information. The configuration may include an indication of which measurement ID is associated with which type of measurement information. In some aspects, source node 702 configures target node 706 and target node 708 with the one or more measurement IDs via a Class 1 AI/ML information request response procedure. In some aspects, the measurement ID(s) configured at target node 706 are different than the measurement ID(s) configured at target node 708. For example, a measurement ID associated with a UE trajectory determination configured at target node 706 may be different than a measurement ID associated with the UE trajectory determination configured at target node 708. In other words, the measurement IDs configured at each target node may be unique to each target node.

Process flow 700 proceeds, at step 724, with source node 702 transmitting, and target node 706 receiving, a handover request to target node 706. For example, target node 706 may receive a handover request from the source node 702 to initiate handing over the UE (not shown) from source node 702 to target node 706. In some aspects, source node 702 conveys the handover request via a particular interface. For example, source node 702 may transmit the handover request via a XN application protocol (XN-AP) interface.

The handover request transmitted to target node 706 may include at least an ID of source node 702 and the persistent UEID previously provided to source node 702 at step 720. In some aspects, source node 702 may also include a particular set of information elements and/or parameter values in the handover request. For example, the source node 702 may transmit the handover request to convey one or more parameters, such as one or more of the AI/ML measurement IDs (e.g., also configured at target node 706 and/or target node 708 at step 722) indicating measurement information for the target node 706 and/or target node 708 to feedback to source node 702, predicted trajectory information for the UE predicted by the source node 702 using the ML model, predicted traffic for the UE predicted by the source node 702 using the ML model, predicted QoS for the UE predicted by the source node 702 using the ML model, predicted QoE for the UE predicted by the source node 702 using the ML model, beam(s) associated with predicted cell(s) for the UE predicted by the source node 702 using the ML model, beam trajectory for the UE predicted by the source node 702 using the ML model, and/or the like. The information included in the handover request may indicate to target node 706 that source node 702 is requesting feedback on predicted information (e.g., included in the handover request) associated with the UE.

In response to receiving the handover request, handover is performed to transfer the UE from communicating in a cell associated with source node 702 to communicating in a cell associated with target node 706 (handover is not shown). Process flow 700 then proceeds, at step 726 with target node 706 transmitting an information update message (e.g., an AI/ML information update message) to source node 702. The information update message may include the persistent UEID assigned to the UE to let source node 702 know that the information included in the information update message is associated with the UE (e.g., associated with this persistent UEID). The information update message may include feedback information associated with the UE, where the feedback information may comprise feedback on the predicted information for the UE included in the handover request. For example, the feedback information may include trajectory feedback for the UE, predicted traffic feedback for the UE, predicted QoS feedback for the UE, predicted QoE feedback for the UE, predicted beam feedback for the UE, and/or the like. Transmission of this information to source node 702 may enable source node 702 to refine the ML model configured to generate predicted information for the UE. In some aspects, the information update message is transmitted via an XN-AP interface.

Target node 706 may know to send the information update message to source node 702 based on receiving the ID for source node 702 in the handover request transmitted at step 724. Further, target node 706 may determine what information to include in the information update message based on the one or more AI/ML measurement IDs included in the handover request, transmitted to target node 706 at step 724. The AI/ML measurement IDs included in the handover request may be IDs configured at target node 706, which are unique to target node 706.

Process flow 700 then proceeds, at step 728, with target node 706 transmitting a handover request (e.g., the second handover request in FIG. 7A) to target node 708. For example, target node 708 may receive a handover request from the target node 706 to initiate handing over the UE (not shown) from a cell associated with target node 706 to a cell associated with target node 708. Similar to the handover request transmitted at step 724, the handover request transmitted at step 728 includes the ID of source node 702 and the persistent UEID associated with the UE being handed over. The handover request may also include some and/or all of the additional information described above with respect to the handover request communicated, at step 724, between source node 702 and target node 706.

In some cases, the handover request includes AI/ML measurement IDs configured at target node 708, which are unique to target node 708. Target node 706 may have knowledge of these AI/ML measurement IDs based on source node 702 including the AI/ML measurement IDs, specific to target node 708, in the original handover request transmitted from source node 702 to target node 706, at step 724. Source node 702 may include the AI/ML measurement IDs for target node 708 in the handover request, transmitted at step 724, based on predicted trajectory information for the UE indicating that the UE is predicted to hand over to target node 708.

In response to receiving the handover request, handover is performed to transfer the UE from communicating in the cell associated with target node 706 to communicating in the cell associated with target node 708 (handover is not shown). Process flow 700 then proceeds, at step 730 with target node 708 transmitting an information update message (e.g., an AI/ML information update message) to source node 702. The information update message may include the persistent UEID assigned to the UE to let source node 702 know that the information included in the information update message is associated with the UE (e.g., associated with this persistent UEID). Target node 708 may know to send the information update message to source node 702 based on receiving the ID for source node 702 in the handover request at step 728.

Target node 708 may determine what information to include in the information update message based on the one or more AI/ML measurement IDs included in the handover request, transmitted to target node 708 at step 728. The information included in the information update message may include some and/or all of the information described above with respect to the information update message communicated, at step 726, between source node 702 and target node 706. Further, the information update message transmitted to source node 702 at step 730 may include UE performance data, such as information about throughput, latency, and/or the like. In some aspects, the information update message is a class 2 AI/ML message.

Transmission of this information to source node 702 may enable source node 702 to further refine the ML model configured to generate predicted information for the UE. For example, source node 702 may determine that the information received in information update message, transmitted at step 730, is associated with the UE based on the persistent UEID included in the message, and use this information to adjust one or more weights and/or parameters of the ML model.

Although FIG. 7A illustrates only two handover procedures for a UE, in some other examples, a UE may undergo a plurality of handovers to cells of different target nodes. A handover request and an information update message (e.g., similar to the handover requests and information update messages described with respect to FIG. 7A) may be communicated per handover, to at least transfer communication of the UE to a new cell associated with a target node and have the target node provide feedback information to a source/predicting node.

In some aspects, the persistent UEID generated and allocated to a UE may need to be updated, for example, for security purposes. FIG. 7B illustrates steps for obtaining a new persistent UEID for a UE subject to handover. Specifically, FIG. 7B depicts another process flow 750 for communications in a network between network entities, such as a source node 702 and two predicted target nodes 706, 708, and an AMF 710 that are used to support ML-based UE mobility. Steps 720, 722, 724, and 726 are similar to steps 720, 722, 724, and 726 described above with respect to FIG. 7A. However, process flow 750 further includes steps 740, 742, 744, and 746 for obtaining a new persistent UEID for the UE (not shown).

As shown in FIG. 7B, after transmitting a persistent UEID to source node 702 at step 720, performing an AI/ML measurement configuration procedure at step 722, and transmitting a handover request to target node 706 at step 724, target node 706 may determine that new persistent UEID for the UE subject to the handover request is needed. Accordingly, at step 740, target node 706 may transmit a handover response to source node 702 acknowledging receipt of the handover request at step 724, and further request a new persistent UEID for the UE at step 742. For example, at step 742, target node 706 may transmit, to AMF 710, a path switch request. The request may include the currently assigned persistent UEID of the UE. In response to receiving the request, AMF 710 may determine which UE the persistent UEID belongs to and assign a new persistent UEID to this identified UE. Thus, at step 744, AMF 710 may respond to the path switch request with a path switch response (e.g., may send this response to target node 706). The path switch response may include the persistent UEID previously assigned to the UE (e.g., old persistent UEID) as well as the new persistent UEID assigned to the UE (e.g., new persistent UEID).

Thus, when transmitting the information update message to source node 702, at step 726, target node 706 may include in the message the old persistent UEID and the new persistent UEID associated with the UE.

Source node 702 may determine which UE the information update message corresponds to, based on the old persistent UEID included in the message. However, because the message further includes the new persistent UEID assigned to the UE, source node 702 may realize that the UE's ID was updated, and thus, store, at step 746, the new persistent UEID assigned to the UE.

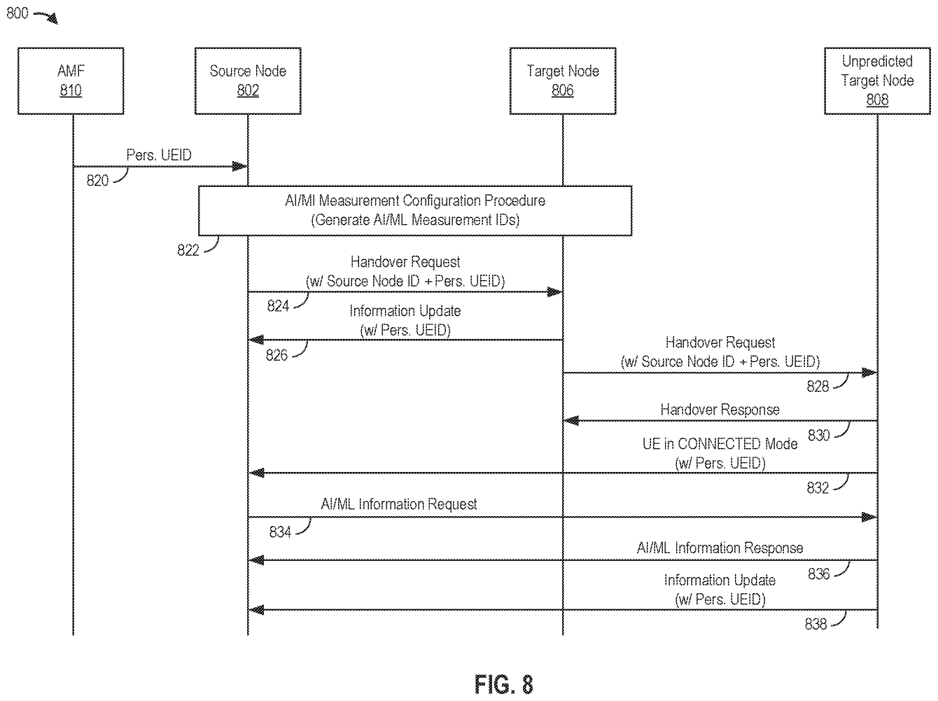

In FIGS. 7A and 7B, the UE is handed over to target nodes (e.g., target nodes 706 and 708) which the UE determined to be in the trajectory path of the UE. Thus, these target nodes were pre-configured with one or more measurement IDs prior to the initiation of both handover procedures. In some cases, however, a target node that a UE is handed over to may not be a target node predicted by a source/predicting node. As such, this node may not be pre-configured with one or more measurement IDs for reporting feedback for a UE when the UE is handed over to a cell of this unpredicted target node. FIG. 8 illustrates a scenario where a UE is handed over to a cell of an unpredicted target node, and how feedback information associated with the UE is obtained from this unpredicted target node.

In particular, FIG. 8 depicts another process flow 800 for communications in a network between network entities, such as a source node 802, a predicted target node 806 (simply referred to as “target node 806”), and an unpredicted target node (simply referred to as “target node 808”), and an AMF 810 that are used to support ML-based UE mobility.

Steps 820-828 in process flow 800 are similar to steps 720-728 in process flow 700 of FIG. 7A; however, at step 822 only one target node (e.g., target node 706) is pre-configured instead of both target nodes. Specifically, in process flow 800, target node 706 may be a node predicted by source node 802 to be within a UE's predicted trajectory, while target node 808 is not predicted by source node 802. As such, only target node 806 is pre-configured.

After performing the handover of the UE from a cell of source node 802 to a cell of target node 806, another handover request is transmitted, from target node 806 to target node 808 at step 828, to initiate another handover of the UE from the cell of target node 806 to target node 808.

The handover request transmitted to target node 808, at step 828, may include at least an ID of source node 802 and the persistent UEID previously assigned to the UE and provided to source node 802 at step 820. In some aspects, target node 806 may also include a particular set of information elements and/or parameter values in the handover request. For example, target node 806 may transmit the handover request to convey one or more parameters, predicted trajectory information for the UE, predicted traffic for the UE, predicted QoS for the UE, predicted QoE for the UE, predicted beam(s) associated with predicted cell(s) for the UE, predicted beam trajectory for the UE, and/or the like (e.g., information previously transmitted to target node 806 from source node 802). The handover request may not include one or more of the AI/ML measurements IDs given target node 808 was not pre-configured with any measurement IDs.

In response to receiving the handover request, at step 830, target node 808 transmits a handover response to target node 806 acknowledging receipt of the handover request transmitted at step 828.

Further, based on the information included in the handover request, target node 808 may determine that the UE is subject to AI/ML measurement and/or feedback collection. As such, at step 832, target node 808 transmits, to source node 802, information indicating that the UE, associated with the persistent UEID included in the transmittal, is operating in a connected mode with target node 808. Target node 808 may use the ID of source node 802 included in the handover request to determine which source node 802 this information is to be transmitted to.

Process flow 800 then proceeds with source node 802 configuring target node 808 to provide AI/ML feedback information associated with the UE to source node 802. For example, at step 834, source node 802 transmits, to target node 808, an AI/ML information request, and, at step 836, target node 808 responds with an AI/ML information response to the request. Transmission of the AI/ML information request may configure target node 808 with one or more measurement IDs, and request that target node 808 provided feedback for at least one of these one or more measurement IDs.

Process flow 800 proceeds, at step 838, with target node 808 transmitting an information update message to source node 802. The information update message may include the persistent UEID assigned to the UE to let source node 802 know that the information included in the information update message is associated with the UE (e.g., associated with this persistent UEID). The information update message may include feedback information associated with the UE. The feedback information may comprise feedback on the predicted information for the UE included in the handover request (e.g., transmitted to target node 808 at step 828). For example, the feedback information may include trajectory feedback for the UE, predicted traffic feedback for the UE, predicted QoS feedback for the UE, predicted QoE feedback for the UE, predicted beam feedback for the UE, and/or the like. Transmission of this information to source node 802 may enable source node 7802 to refine the ML model configured to generate predicted information for the UE. In some aspects, the information update message is transmitted via an XN-AP interface. Target node 808 may know to send the information update message to source node 802 based on receiving the ID for source node 802 in the handover request transmitted at step 828.

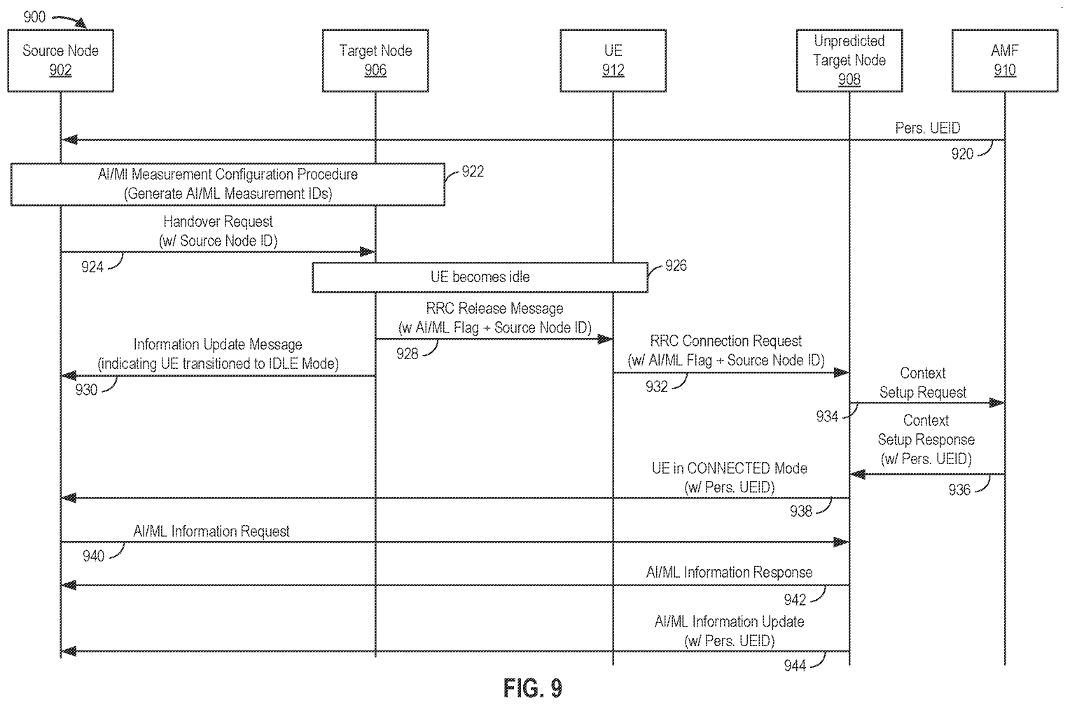

In some aspects, the UE may transition to an idle state or an inactive state, and at a later time attempt to re-establish or resume an RRC connection with another cell, for example, associated with another target node. To continue to receive feedback information associated with the UE, even after the UE transitions between RRC states, aspects herein provide various signaling mechanisms. These signaling mechanisms are described below with respect to FIGS. 9, 10, 11A, and 11B.

In particular, FIG. 9 depicts another process flow 900 for communications in a network between network entities, such as a source node 902, a predicted target node 906 (simply referred to herein as “target node 906”), and an unpredicted target node 908 (simply referred to herein as “target node 908”), a UE 912, and an AMF 910 that are used to support ML-based UE mobility.

Steps 920-924 in process flow 900 are similar to steps 820-824 in process flow 800 of FIG. 8, where a persistent UEID is received for a UE (e.g., UE 912 in this example), only one target node (e.g., target node 906) is pre-configured by source node 902 instead of both target nodes, and a handover request is transmitted from source node 902 to initiate the handover of UE 912 from a cell associated with source node 902 to a cell of target node 906. Specifically, in process flow 900, target node 906 may be a node predicted by source node 902 to be within UE 912′s predicted trajectory, while target node 908 is not predicted by source node 902. As such, only target node 906 is pre-configured.

Based on the handover request transmitted at step 924, UE 912 is transferred to communicate within a cell associated with target node 906. However, subsequent to the handover procedure to target node 906, UE 912 becomes idle.

Target node 906 detects inactivity of UE 912 (e.g., detects an expiration of an inactivity timer), after the UE become idle. Thus, at step 928, target node 906 transmits an RRC release message to UE 912 indicating that UE 912 is to transition from the connected mode to an idle mode or an inactive mode of UE 912 (e.g., based on detecting the inactivity of UE 912). For example, where the RRC release message has suspension configured, the RRC release message indicates to transition to the inactive mode. Further, where the RRC release message does not have suspension configured, the RRC release message indicates to transition to the idle mode. UE 912 transitions to an idle mode in response to receiving the RRC release message. The RRC release message may include an ID of source node 902. Further, the RRC release message may include an indication of when an inactivity of UE 912 was detected by target node 906. This indication may be referred to as an “AI/ML flag” included in the RRC release message.

At step 930, target node 906 further transmits an information update message to source node 902. The information update message may include the persistent UEID assigned to the UE to let source node 902 know that the information included in the information update message is associated with the UE (e.g., associated with this persistent UEID). The information update message may include feedback information associated with the UE, where the feedback information may comprise feedback on the predicted information for the UE included in the handover request.

Further, in this example, the information update message may include information indicating that the UE 912 has transitioned from a connected mode to an idle mode. This information helps inform source node 902 about a state of UE 912.

Process flow 900 then proceeds, at step 932, with UE 912 initiating an RRC connection with target node 908 by transmitting an RRC connection request (e.g., RRC connected message, RRC setup request, or RRC connection re-establishment request). The RRC connection request initiates the transition of UE 912 from the idle mode to the connected mode (e.g., UE 912 is operating in the connected mode with target node 908 at the successful completion of this connection). In other words, at the successful completion of the connection, UE 912 is connected to and communicating within a cell associated with target node 908. The RRC connection request transmitted, at step 932, may include an ID of source node 902 (e.g., previously provided to UE 912 in the RRC release message transmitted to UE 912 at step 928). Further, the RRC reconnection request may include an AI/ML flag indicating when inactivity of UE 912 was previously detected by target node 906 (e.g., previously provided to UE 912 in the RRC release message transmitted to UE 912 at step 928).

Process flow 900 proceeds, at steps 934 and 936, with target node 908 transmitting a context setup request to AMF 910 and receiving a context setup response from AMF 910, respectively. In some aspects, the context setup request transmitted at step 934, by target node 908 to AMF 910, includes the ID of source node 902. In some aspects, the context setup request is a request for the persistent UEID assigned to UE 912. As such, the context setup response, transmitted by AMF 910 and received by target node 908 in response to the context setup request, may include the persistent UEID assigned to UE 912.

Because target node 908 is not a network node predicted by source node 902, and thus was not pre-configured to provide feedback information for UE 912 to source node 902, similar steps as steps 832-838 described above with respect to process flow 800 in FIG. 8 may be performed.

For example, at step 938, target node 908 transmits to source node 902, information indicating that UE 912, associated with the persistent UEID included in the transmittal, is operating in a connected mode with target node 908. Process flow 900 then proceeds with source node 902 configuring target node 908 to provide AI/ML feedback information associated with the UE 912 to source node 902. For example, at step 940, source node 902 transmits, to target node 908, an AI/ML information request, and, at step 942, target node 808 responds with an AI/ML information response to the request. At step 944, target node 908 then transmits an information update message to source node 902. Transmission of this information to source node 902 may enable source node 902 to refine the ML model configured to generate predicted information for UE 912.

This cycle of steps illustrated in process flow 900 may continue as UE 912 undergoes RRC state transitions (e.g., connected mode to idle mode to connected mode). Performance of such steps in process flow 900 may allow source node 902 to receive continuous UE-related data for re-training the ML model even in cases where the UE undergoes RRC transitions.

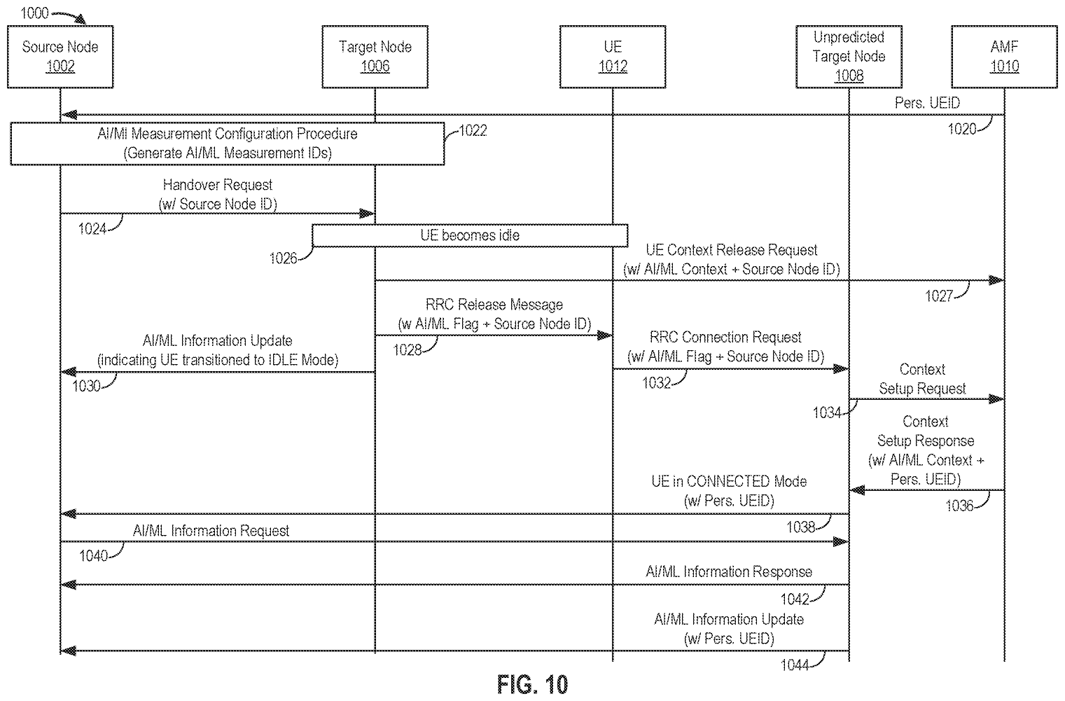

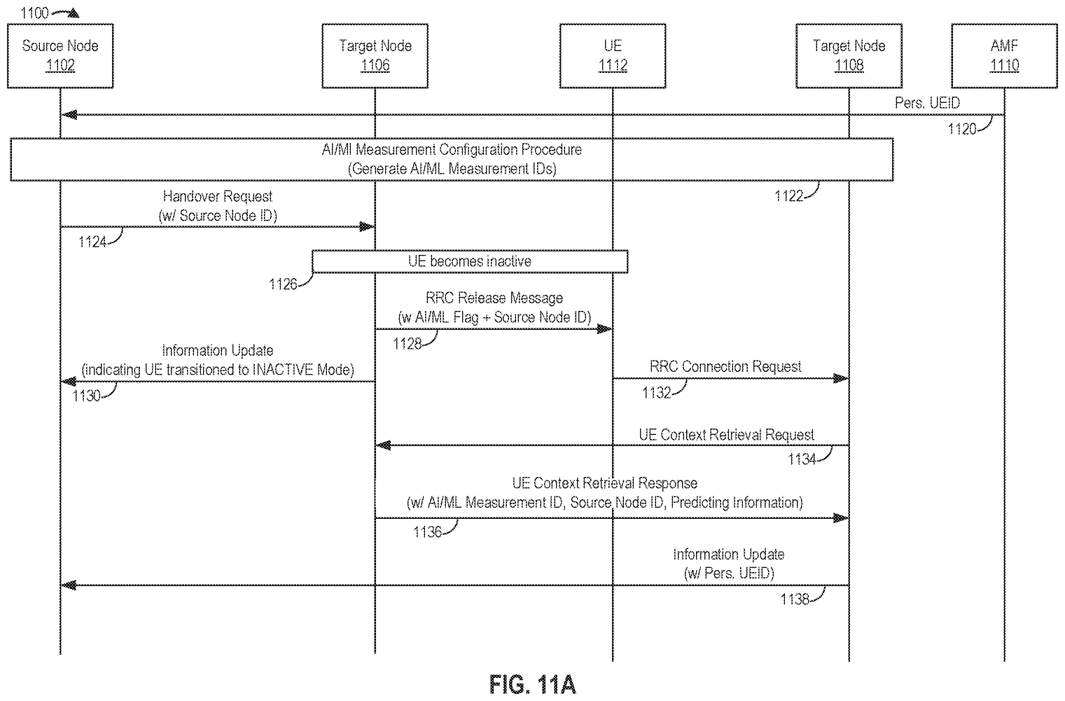

In some aspects, a context setup response, transmitted by an AMF in response to receiving a context setup request from a target node (e.g., shown at steps 934 and 936 in process flow 900 of FIG. 9) additionally includes predicted information for a UE for which the context setup is requested. Predicted information for the UE included in the context setup request to be used by the target node when generating feedback. This scenario is illustrated in FIG. 10.

FIG. 10 depicts another process flow 1000 for communications in a network between network entities, such as a source node 1002, a predicted target node 1006 (simply referred to herein as “target node 1006”), and an unpredicted target node 1008 (simply referred to herein as “target node 1008”), a UE 1012, and an AMF 1010 that are used to support ML-based UE mobility.

Steps 1020-1026 are similar to steps 920-926 in process flow 900 of FIG. 9, steps 1028-1034 are similar to steps 928-934 in process flow 900 of FIG. 9, and steps 1038-1044 are similar to steps 938-944 in process flow 900 of FIG. 9. However, FIG. 10 additionally includes step 1027 for transmitting, by target node 1006 to AMF 1010 at step 1027, a UE context release request message after detecting inactivity of the UE (e.g., UE has become idle) at step 1026. This UE context release request message may include an ID of source node 1002, as well as predicted information for UE 1012.

By providing this information to AMF 1010, when target node 1008 transmits the context setup request to AMF 1010, at step 1034, AMF 1010 may additionally include in the context setup response the predicted information for target node 1008's information.

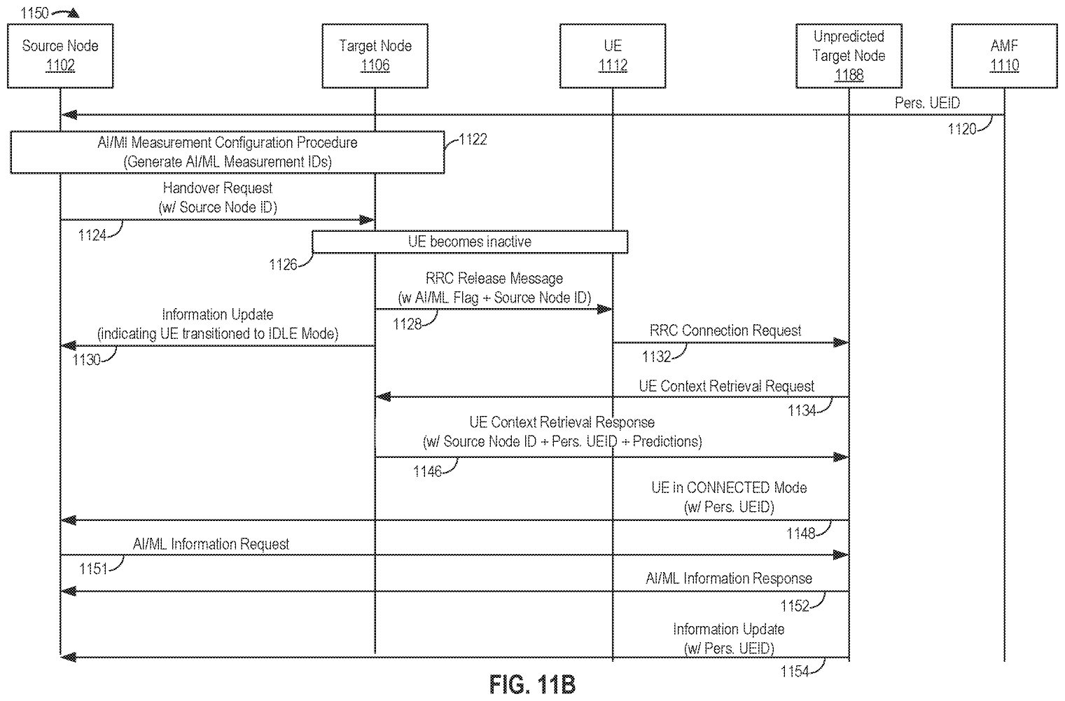

In some other aspects, a target node may obtain predicted information for a UE from a previous target node that the UE was previously connected to (e.g., prior to handover to another target node from this previous node). FIGS. 11A-11B illustrate this scenario. More specifically, FIG. 11A illustrates a target node requesting information from a previous target node connected to the UE, where the requesting target node is a node predicted by a source node (e.g., and pre-configured with one or more AI/ML measurement IDs). Alternatively, FIG. 11B illustrates a target node requesting information from a previous target node connected to the UE, where the requesting target node is not a no predicted by a source node (e.g., nor pre-configured with one or more AI/ML measurement IDs.)

For example, FIG. 11A depicts another process flow 1100a for communications in a network between network entities, such as a source node 1102 and two predicted target nodes 1106, 1108 (simply referred to herein as “target node 1106” and “target node 1108,” respectively), a UE 1112, and an AMF 1110 that are used to support ML-based UE mobility.

Process flow 1100 begins, at step 1120, by AMF 1110 providing, to source node 1102, a persistent UEID of UE 1112. At step 1122, source node 1102, target node 1106, and target node 1108 perform an AI/ML measurement configuration procedure. At step 1124, source node 1102 transmits, and target node 1106 receives, a handover request to transfer UE 1112 from communicating on a cell associated with source node 1102 to communicating on a cell associated with target node 1106. In response to receiving this request, the handover is carried out to hand over UE 1112 to target node 1106.

Process flow 1100 proceeds, at step 1126, with UE 1112 becoming inactive. Target node 1106 detects inactivity of UE 1112 (e.g., detects an expiration of an inactivity timer), after UE 1112 becomes inactive. Thus, target node 1106 transmits, at step 1128, an RRC release message to UE 1112 indicating that UE 1112 is to transition from the connected mode to an inactive mode (e.g., based on detecting the inactivity of UE 1112). UE 1112 transitions to the inactive mode in response to receiving the RRC release message. At step 1130, target node 1106 further transmits an information update message to source node 1102.

Process flow 1100 then proceeds, at step 1132, with UE 1112 initiating an RRC connection with target node 1108 and transmitting an RRC connection request (e.g., an RRC resume message) to target node 1108 to resume its connection with target node 1108. In certain embodiments, the RRC connection request includes an ID of source node 1102. In certain embodiments, the RRC connection request includes one or more AI/ML measurement IDs. In this case where the AI/ML measurement IDs are included in the RRC connection request, target node 1108 may determine to retrieve prediction information for UE 1112 previously predicted by a source node, e.g., source node 1102, associated with the AI/ML measurement IDs. In other words, the AI/ML measurement IDs included in the RRC connection request may be uniquely associated with source node 1102, and more specifically an ID of source node 1102.

In response to receiving the RRC connection request, and UE 1112 transitioning from the inactive mode to a connected mode, target node 1108 transmits, to target node 1106 at step 1134, a UE context retrieval message (e.g., that may include the ID of source node 1102). Target node 1106 responds to the UE context retrieval message with a UE context retrieval response, at step 1136. The UE context retrieval response may include predicting information for UE 1112 (e.g., previously predicted by source node 1102), as well as the ID of source node 1102. Further, in this case, because target node 1108 is a predicted node, and thus configured with one or more AI/ML measurement IDs, the UE context retrieval response may further include at least one of the one or more AI/ML measurement IDs to inform target node 1108 about the feedback information that target node 1108 is expected to report, to source node 1102, for UE 1112.

Process flow 1100 then proceeds, at step 1138, with target node 1108 transmitting an information update message to source node 1102. The information update message may include the persistent UEID assigned to the UE to let source node 1102 know that the information included in the information update message is associated with the UE (e.g., associated with this persistent UEID). Target node 1108 may know to send the information update message to source node 1102 based on receiving the ID for source node 1102 in the handover request at step 1128. Target node 1108 may determine what information to include in the information update message based on the one or more AI/ML measurement IDs included in the UE context retrieval response, transmitted to target node 1108 at step 1136.

FIG. 11B includes steps similar to FIG. 11A; however, the target node requesting the UE context information (e.g., target node 1188) in process flow 1150 in FIG. 11B is an unpredicted node. As such, the UE context retrieval response provided, at step 1134, may not include AI/ML measurement IDs (e.g., given target node 1188 would not have pre-configured with such IDs).

To provide feedback information to source node 1102, target node 1188 performs steps 1148-4454, which are similar to steps 832-838 in process flow 800 of FIG.

### Example Operations

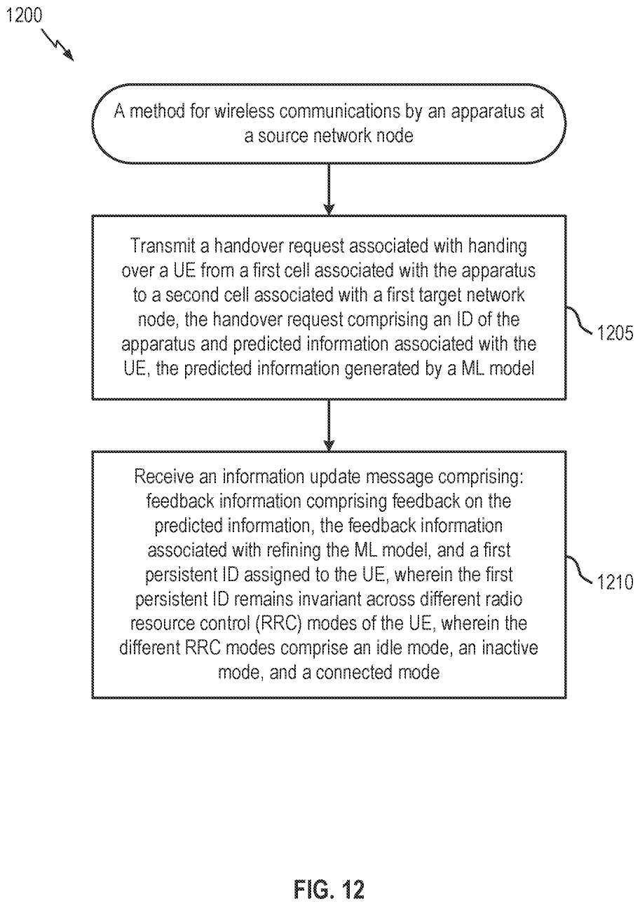

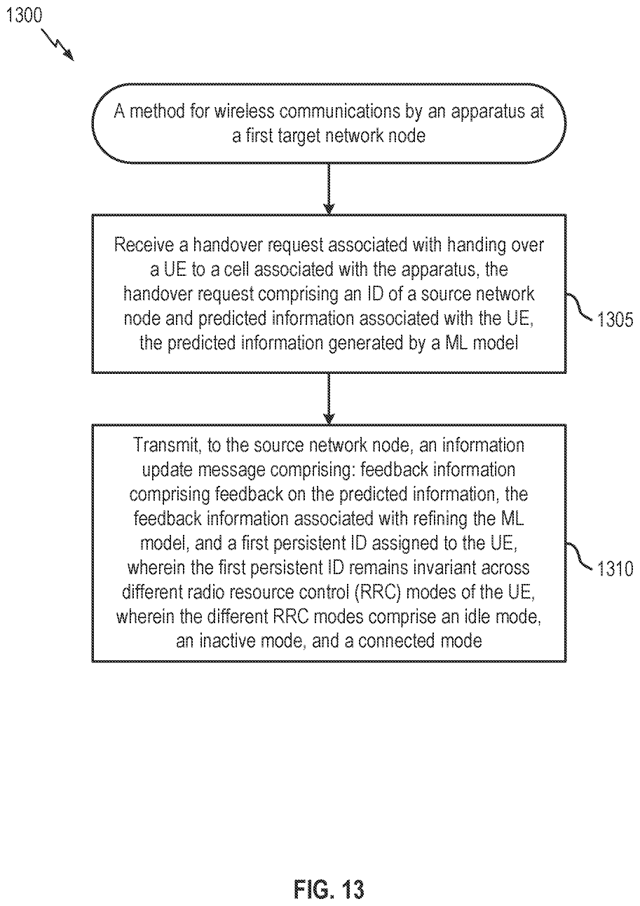

FIG. 12 shows a method 1200 for wireless communications by an apparatus at a source network node, such as BS 102 of FIGS. 1 and 3, or a disaggregated base station as discussed with respect to FIG. 2.

Method 1200 begins at step 1205 with transmitting a handover request associated with handing over a UE from a first cell associated with the apparatus to a second cell associated with a first target network node, the handover request comprising an ID of the apparatus and predicted information associated with the UE, the predicted information generated by a ML model.

Method 1200 then proceeds to step 1210 with receiving an information update message comprising: feedback information comprising feedback on the predicted information, the feedback information associated with refining the ML model, and a first persistent ID assigned to the UE, wherein the first persistent ID remains invariant across different radio resource control (RRC) modes of the UE, wherein the different RRC modes comprise an idle mode, an inactive mode, and a connected mode.

In certain aspects, method 1200 further includes receiving the first persistent ID assigned to the UE from an access and mobility management function (AMF) prior to transmitting the handover request, wherein the handover request further comprises the first persistent ID assigned to the UE.

In certain aspects, method 1200 further includes configuring the first target network node with one or more measurement IDs, each of the one or more measurement IDs being associated with measurement information relating to the ML model.

In certain aspects, the one or more measurement IDs are unique to the first target network node.

In certain aspects, the handover request further comprises at least one of the one or more measurement IDs, and the feedback information associated with the UE comprises the measurement information for the UE associated with the at least one of the one or more measurement IDs.

In certain aspects, the predicted information comprises at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

In certain aspects, the feedback on the predicted information comprises at least one of: trajectory feedback for the UE; predicted traffic feedback for the UE; predicted QoS feedback for the UE; predicted QoE feedback for the UE; or predicted beam feedback for the UE.

In certain aspects, step 1205 includes transmitting the handover request to the first target network node; and step 1210 includes receiving the information update message from the first target network node.

In certain aspects, step 1205 includes transmitting the handover request to the first target network node; and step 1210 includes receiving the information update message from a second target network node.

In certain aspects, prior to receiving the information update message, method 1200 further includes receiving information indicating that the UE is operating in a connected mode with the second node.

In certain aspects, method 1200 further includes configuring the second node to provide the feedback information associated with the UE.

In certain aspects, the information indicating the UE is operating in the connected mode with the second node comprises, at least, the first persistent ID assigned to the UE.

In certain aspects, configuring the second target network node to provide the feedback information further comprises configuring the second target network node with one or more measurement IDs, each of the one or more measurement IDs being associated with measurement information relating to the ML model.

In certain aspects, the feedback information associated with the UE comprises the measurement information for the UE associated with the one or more measurement IDs.

In certain aspects, the information update message further comprises a second persistent ID previously assigned to the UE.

In certain aspects, the information update message further comprises information about a mode of the UE, wherein the mode of the UE comprises an idle mode or an inactive mode.

In certain aspects, method 1200 further includes receiving information indicating that the UE is operating in a connected mode with a second target network node.

In certain aspects, method 1200 further includes transmitting the predicted information associated with the UE to the second target network node.

In certain aspects, method 1200, further includes executing the ML model to generate the predicted information associated with the UE; and refining the ML model using the feedback information.

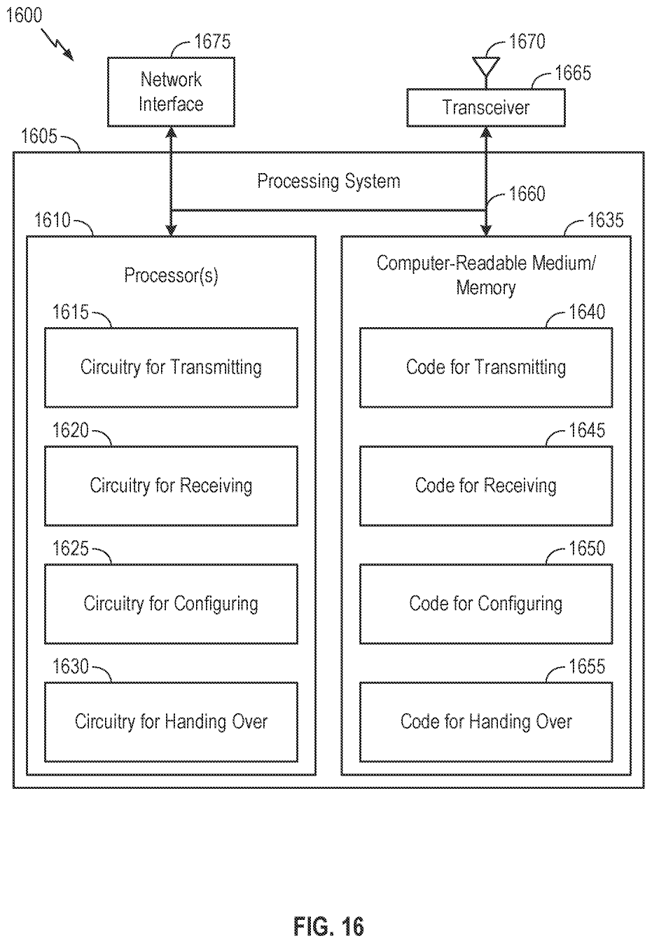

In certain aspects, method 1200, or any aspect related to it, may be performed by an apparatus, such as communications device 1600 of FIG. 16, which includes various components operable, configured, or adapted to perform the method 1200. Communications device 1600 is described below in further detail.

Note that FIG. 12 is just one example of a method, and other methods including fewer, additional, or alternative steps are possible consistent with this disclosure.

FIG. 13 shows a method 1300 for wireless communications by an apparatus at a first target network node, such as BS 102 of FIGS. 1 and 3, or a disaggregated base station as discussed with respect to FIG. 2.

Method 1300 begins at step 1305 with receiving a handover request associated with handing over a UE to a cell associated with the apparatus, the handover request comprising an ID of a source network node and predicted information associated with the UE, the predicted information generated by a ML model.

Method 1300 then proceeds to step 1310 with transmitting, to the source network node, an information update message comprising: feedback information comprising feedback on the predicted information, the feedback information associated with refining the ML model configured to generate the predicted information, and a first persistent ID assigned to the UE, wherein the first persistent ID remains invariant across different radio resource control (RRC) modes of the UE, wherein the different RRC modes comprise an idle mode, an inactive mode, and a connected mode.

In certain aspects, the handover request further comprises the first persistent ID assigned to the UE.

In certain aspects, the apparatus is configured with one or more measurement IDs, each of the one or more measurement IDs being associated with measurement information relating to the ML model.

In certain aspects, the handover request further comprises at least one of the one or more measurement IDs, and the feedback information associated with the UE comprises the measurement information for the UE associated with the at least one of the one or more measurement IDs.

In certain aspects, the predicted information comprises at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

In certain aspects, the feedback on the predicted information comprises at least one of: trajectory feedback for the UE; predicted traffic feedback for the UE; predicted QoS feedback for the UE; or predicted QoE feedback for the UE; or predicted beam feedback for the UE.

In certain aspects, the first persistent ID is obtained using a second persistent ID previously assigned to the UE, and the information update message further comprises the second persistent ID previously assigned to the UE.

In certain aspects, step 1305 includes receiving the handover request from a first target network node.

In certain aspects, method 1300 further includes transmitting, to the source network node, prior to transmitting the information update message, information indicating that the UE is operating in a connected mode with the apparatus.

In certain aspects, the information indicating the UE is operating in the connected mode with the apparatus comprises, at least, the first persistent ID assigned to the UE.

In certain aspects, method 1300 further includes receiving, from the source network node, the predicted information associated with the UE, and the predicted information comprises at least one of: predicted trajectory information for the UE, predicted traffic for the UE, predicted QoS for the UE, predicted QoE for the UE; one or more predicted beams associated with one or more predicted cells for the UE; or predicted beam trajectory for the UE.

In certain aspects, the apparatus is configured with one or more measurement IDs, each of the one or more measurement IDs being associated with measurement information relating to the ML model.

In certain aspects, the feedback information associated with the UE comprises the measurement information for the UE associated with the one or more measurement IDs.

In certain aspects, method 1300 further includes receiving, from a second UE, a RRC connection request requesting to re-establish or resume an RRC connection with the second UE, the RRC connection request comprising the ID of the source network node.

In certain aspects, the RRC connection request further comprises an indication of when an inactivity of the second UE was detected by the first target network node.

In certain aspects, method 1300 further includes receiving, from an AMF, the ID of the source network node and a secondary persistent ID assigned to the second UE.

In certain aspects, method 1300 further includes receiving, from the AMF, one or more predictions for the second UE, and the one or more predictions comprise at least one of: predicted trajectory information for the second UE; predicted traffic for the second UE; predicted QoS for the second UE; predicted QoE for the second UE; one or more predicted beams associated with one or more predicted cells for the second UE; or predicted beam trajectory for the second UE.

In certain aspects, method 1300 further includes transmitting, to the first target network node previously having an RRC connection established with the apparatus, a request for context associated with the second UE.

In certain aspects, method 1300 further includes receiving, from the first target network node, the context associated with the second UE, the context associated with the second UE comprising the ID of the source network node.

In certain aspects, the context associated with the second UE further comprises second predicted information for the second UE, the second predicted information comprising at least one of: predicted trajectory information for the second UE; predicted traffic for the second UE; predicted QoS for the second UE; predicted QoE for the second UE; one or more predicted beams associated with one or more predicted cells for the second UE; or predicted beam trajectory for the second UE.

In certain aspects, the apparatus is configured with one or more measurement IDs, each of the one or more measurement IDs being associated with measurement information relating to the ML model; and the context associated with the second UE further comprises the one or more measurement IDs.

In certain aspects, step 1305 includes receiving the handover request from the source network node.

In certain aspects, method 1300 further includes handing over the UE to the cell associated with the apparatus.

In certain aspects, method 1300 further includes transmitting, to a second target network node, another handover message used to initiate a handover of the UE from the cell associated with the apparatus to another cell associated with the second target network node, the handover message comprising, at least, the ID of the source network node.

In certain aspects, the information update message further comprises information indicating that the UE has transitioned from a connected mode to an idle mode or an inactive mode.

In certain aspects, method 1300 further includes detecting inactivity of the UE and transmitting, to the UE, an RRC release message indicating that the UE is to transition from the connected mode to the idle mode or the inactive mode. The RRC release message may include the ID of the source network node.

In certain aspects, the RRC release message further comprises an indication of when the inactivity of the UE was detected by the first target network node.

In certain aspects, method 1300 further includes transmitting, to an AMF, the ID of the source network node.

In certain aspects, method 1300 further includes transmitting, to the AMF, one or more predictions for the UE, and the one or more predictions comprise at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

In certain aspects, method 1300 further includes receiving, from a second target network node, a request for context associated with the UE.

In certain aspects, method 1300 further includes transmitting, to the second target network node, the context associated with the UE, the context associated with the UE comprising the ID of the source network node.

In certain aspects, the context associated with the UE further comprises one or more predictions for the UE, the one or more predictions comprising at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

In certain aspects, the second target network node is configured with one or more measurement IDs, each of the one or more measurement IDs being associated with measurement information relating to the ML model; and the context associated with the UE further comprises the one or more measurement IDs.

In certain aspects, method 1300, or any aspect related to it, may be performed by an apparatus, such as communications device 1600 of FIG. 16, which includes various components operable, configured, or adapted to perform the method 1300. Communications device 1600 is described below in further detail.

Note that FIG. 13 is just one example of a method, and other methods including fewer, additional, or alternative steps are possible consistent with this disclosure.

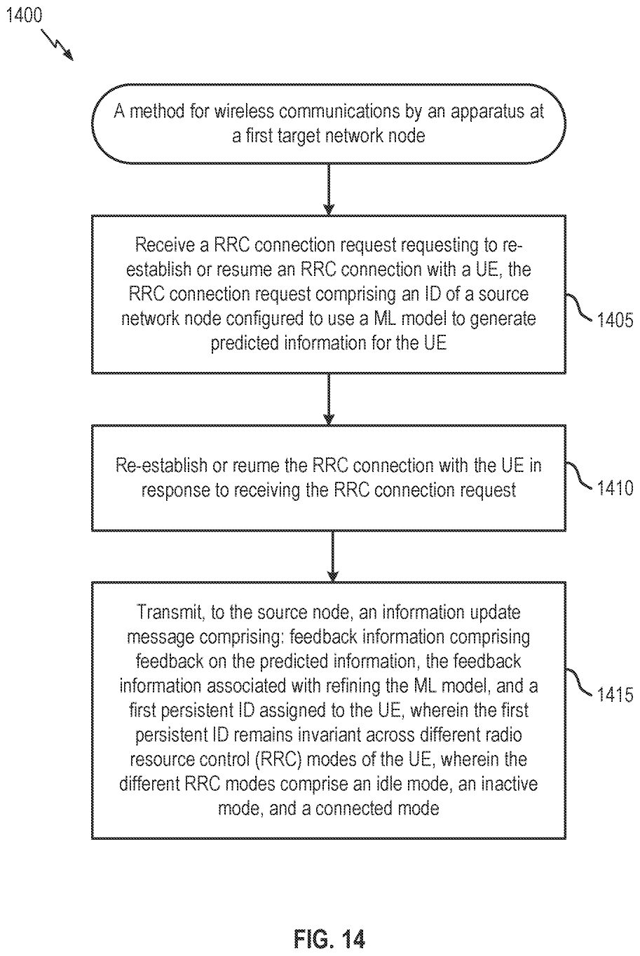

FIG. 14 shows a method 1400 for wireless communications by an apparatus at a first target network node, such as BS 102 of FIGS. 1 and 3, or a disaggregated base station as discussed with respect to FIG. 2.

Method 1400 begins at step 1405 with receiving a RRC connection request requesting to re-establish or resume an RRC connection with a UE, the RRC connection request comprising an ID of a source network node configured to use a ML model to generate predicted information for the UE.

Method 1400 then proceeds to step 1410 with re-establishing or resuming the RRC connection with the UE in response to receiving the RRC connection request.

Method 1400 then proceeds to step 1415 with transmitting, to the source network node, an information update message comprising: feedback information comprising feedback on the predicted information, the feedback information associated with refining the ML model, and a first persistent ID assigned to the UE, wherein the first persistent ID remains invariant across different RRC modes of the UE, wherein the different RRC modes comprise an idle mode, an inactive mode, and a connected mode.

In certain aspects, the RRC connection request further comprises an indication of when an inactivity of the UE was detected by a second target network node.

In certain aspects, method 1400 further includes receiving, from an AMF, the ID of the source node and the first persistent ID assigned to the UE.

In certain aspects, method 1400 further includes receiving, from the AMF, the predicted information for the UE, and the predicted information comprising at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

In certain aspects, method 1400 further includes transmitting, to the second target network node, a request for context associated with the UE.

In certain aspects, method 1400 further includes receiving, from the second target network node, the context associated with the UE, the context associated with the UE comprising the ID of the source network node.

In certain aspects, the context associated with the UE further comprises the predicted information for the UE, the predicted information comprising at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

In certain aspects, the apparatus is configured with one or more measurement IDs, each of the one or more measurement IDs being associated with measurement information relating to the ML model; and the context associated with the UE further comprises the one or more measurement IDs.

In certain aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

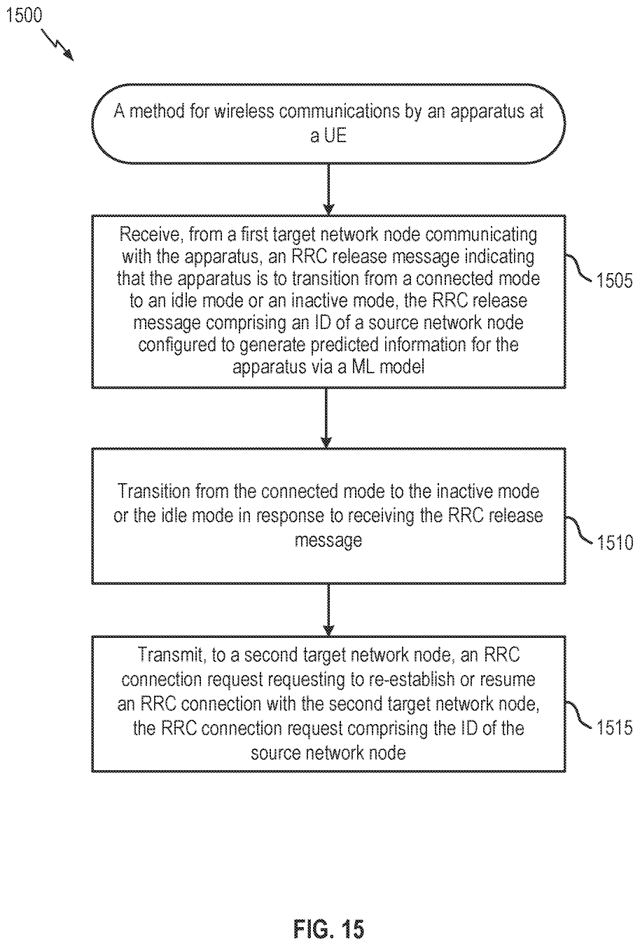

FIG. 15 shows a method 1500 for wireless communications by an apparatus at a UE, such as UE 104 of FIGS. 1 and 3.

Method 1500 begins at step 1505 with receiving, from a first target network node communicating with the apparatus, an RRC release message indicating that the apparatus is to transition from a connected mode to an idle mode or an inactive mode, the RRC release message comprising an ID of a source network node configured to generate predicted information for the apparatus via a ML model.

Method 1500 proceeds to step 1510 with transitioning from the connected mode to the inactive mode or the idle mode in response to receiving the RRC release message

Method 1500 then proceeds to step 1515 with transmitting, to a second target network node, an RRC connection request requesting to re-establish or resume an RRC connection with the second target network node, the RRC connection request comprising the ID of the source network node.

In certain aspects, the RRC release message and the RRC connection request each comprise an indication of when an inactivity of the apparatus was detected by the first target network node.

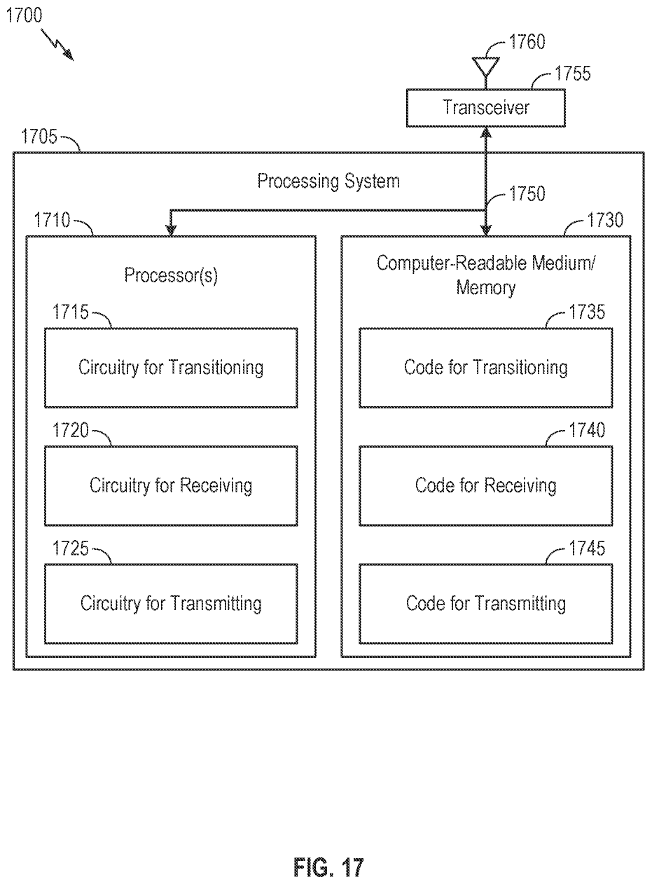

In certain aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

### Example Communications Devices

FIG. 16 depicts aspects of an example communications device 1600. In some aspects, communications device 1600 is a network entity, such as BS 102 of FIGS. 1 and 3, or a disaggregated base station as discussed with respect to FIG. 2.

The communications device 1600 includes a processing system 1605 coupled to a transceiver 1665 (e.g., a transmitter and/or a receiver) and/or a network interface 1675. The transceiver 1665 is configured to transmit and receive signals for the communications device 1600 via an antenna 1670, such as the various signals as described herein. The network interface 1675 is configured to obtain and send signals for the communications device 1600 via communications link(s), such as a backhaul link, midhaul link, and/or fronthaul link as described herein, such as with respect to FIG. 2. The processing system 1605 may be configured to perform processing functions for the communications device 1600, including processing signals received and/or to be transmitted by the communications device 1600.

The processing system 1605 includes one or more processors 1610. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, enable and cause the one or more processors 1610 to perform the method 1200 described with respect to FIG. 12, or any aspect related to it, including any additional steps or sub-steps described in relation to FIG. 12; the method 1300 described with respect to FIG. 13, or any aspect related to it, including any additional steps or sub-steps described in relation to FIG. 13; and the method 1400 described with respect to FIG. 14, or any aspect related to it, including any additional steps or sub-steps described in relation to FIG. 14. Note that reference to a processor of communications device 1600 performing a function may include one or more processors of communications device 1600 performing that function, such as in a distributed fashion.

In the depicted example, the computer-readable medium/memory 1635 stores code for transmitting 1640, code for receiving 1645, code for configuring 1650, and code for handing over 1655. Processing of the code 1640-1655 may enable and cause the communications device 1600 to perform the method 1200 described with respect to FIG. 12, or any aspect related to it; the method 1300 described with respect to FIG. 13, or any aspect related to it; and the method 1400 described with respect to FIG. 14, or any aspect related to it.

The one or more processors 1610 include circuitry configured to implement (e.g., execute) the code stored in the computer-readable medium/memory 1635, including circuitry for transmitting 1615, circuitry for receiving 1620, circuitry for configuring 1625, and circuitry for handing over 1630. Processing with circuitry 1615-1630 may enable and cause the communications device 1600 to perform the method 1200 described with respect to FIG. 12, or any aspect related to it; the method 1300 described with respect to FIG. 13, or any aspect related to it; and the method 1400 described with respect to FIG. 14, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1665 and/or antenna 1670 of the communications device 1600 in FIG. 16, and/or one or more processors 1610 of the communications device 1600 in FIG. 16. Means for communicating, receiving or obtaining may include the transceivers 332, antenna(s) 334, receive processor 338, and/or controller/processor 340 of the BS 102 illustrated in FIG. 3, transceiver 1665 and/or antenna 1670 of the communications device 1600 in FIG. 16, and/or one or more processors 1610 of the communications device 1600 in FIG. 16.

FIG. 17 depicts aspects of an example communications device 1700. In some aspects, communications device 1700 is a user equipment, such as UE 104 described above with respect to FIGS. 1 and 3.

The communications device 1700 includes a processing system 1705 coupled to a transceiver 1755 (e.g., a transmitter and/or a receiver). The transceiver 1755 is configured to transmit and receive signals for the communications device 1700 via an antenna 1760, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1730 via a bus 1750. In certain aspects, the computer-readable medium/memory 1730 is configured to store instructions (e.g., computer-executable code) that when executed by the one or more processors 1710, enable and cause the one or more processors 1710 to perform the method 1500 described with respect to FIG. 15, or any aspect related to it, including any additional steps or sub-steps described in relation to FIG. 15. Note that reference to a processor performing a function of communications device 1700 may include one or more processors performing that function of communications device 1700, such as in a distributed fashion.

In the depicted example, computer-readable medium/memory 1730 stores code for transitioning 1735, code for receiving 1740, and code for transmitting 1745. Processing of the code 1735-1745 may enable and cause the communications device 1700 to perform the method 1500 described with respect to FIG. 15, or any aspect related to it.

The one or more processors 1710 include circuitry configured to implement (e.g., execute) the code stored in the computer-readable medium/memory 1730, including circuitry for transitioning 1715, circuitry for receiving 1720, and circuitry for transmitting 1725. Processing with circuitry 1715-1725 may enable and cause the communications device 1700 to perform the method 1500 described with respect to FIG. 15, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1755 and/or antenna 1760 of the communications device 1700 in FIG. 17, and/or one or more processors 1710 of the communications device 1700 in FIG. 17. Means for communicating, receiving or obtaining may include the transceivers 354, antenna(s) 352, receive processor 358, and/or controller/processor 380 of the UE 104 illustrated in FIG. 3, transceiver 1755 and/or antenna 1760 of the communications device 1700 in FIG. 17, and/or one or more processors 1710 of the communications device 1700 in FIG. 17.

### Example Clauses

Implementation examples are described in the following numbered clauses:

Clause 1: A method for wireless communications by an apparatus at a source network node comprising: transmitting a handover request associated with handing over a UE from a first cell associated with an apparatus to a second cell associated with a first target network node, the handover request comprising an ID of the apparatus and predicted information associated with the UE, the predicted information generated by a ML model; and receiving an information update message comprising: feedback information comprising feedback on the predicted information, the feedback information associated with refining the ML model, and a first persistent ID assigned to the UE, wherein the first persistent ID remains invariant across different radio resource control (RRC) modes of the UE, wherein the different RRC modes comprise an idle mode, an inactive mode, and a connected mode.

Clause 2: The method of Clause 1, further comprising: receiving the first persistent ID assigned to the UE from an access and mobility management function (AMF) prior to transmitting the handover request, wherein the handover request further comprises the first persistent ID assigned to the UE.

Clause 3: The method of any one of Clauses 1-2, further comprising: configuring the first target network node with one or more measurement IDs, each of the one or more measurement IDs being associated with measurement information relating to the ML model.

Clause 4: The method of Clause 3, wherein the one or more measurement IDs are unique to the first target network node.

Clause 5: The method of Clause 3, wherein: the handover request further comprises at least one of the one or more measurement IDs, and the feedback information associated with the UE comprises the measurement information for the UE associated with the at least one of the one or more measurement IDs.

Clause 6: The method of any one of Clauses 1-5, wherein the predicted information comprises at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 7: The method of any one of Clauses 1-6, wherein the feedback on the predicted information comprises at least one of: trajectory feedback for the UE; predicted traffic feedback for the UE; predicted QoS feedback for the UE; predicted QoE feedback for the UE; or predicted beam feedback for the UE.

Clause 8: The method of any one of Clauses 1-7, wherein: transmitting the handover request further comprises transmitting the handover request to the first target network node; and receiving the information update message further comprises receiving the information update message from the first target network node.

Clause 9: The method of any one of Clauses 1-8, wherein: transmitting the handover request further comprises transmitting the handover request to the first target network node; and receiving the information update message further comprises receiving the information update message from a second target network node.

Clause 10: The method of Clause 9, further comprising, prior to receiving the information update message: receiving information indicating that the UE is operating in the connected mode with the second target network node; and configuring the second target network node to provide the feedback information associated with the UE.

Clause 11: The method of Clause 10, wherein the information indicating the UE is operating in the connected mode with the second target network node comprises, at least, the first persistent ID assigned to the UE.

Clause 12: The method of Clause 10, wherein configuring the second target network node to provide the feedback information further comprises configuring the second target network node with one or more measurement IDs, each of the one or more measurement IDs being associated with measurement information relating to the ML model and unique to the second target network node.

Clause 13: The method of Clause 12, wherein the feedback information associated with the UE comprises the measurement information for the UE associated with the one or more measurement IDs.

Clause 14: The method of any one of Clauses 1-13, further comprising: receive a second persistent ID previously assigned to the UE from an access and mobility management function (AMF) prior to transmitting the handover request, storing the second persistent ID in one or more memories of the apparatus, receiving the information update message further comprising the second persistent ID, and storing the first persistent ID assigned to the UE in the one or more memories in place of the second persistent ID.

Clause 15: The method of any one of Clauses 1-14, wherein the information update message further comprises information indicating that the UE is operating in the idle mode or the inactive mode.

Clause 16: The method of Clause 15, further comprising: receiving information indicating that the UE is operating in the connected mode with a second node; and transmitting the predicted information associated with the UE to the second target network node.

Clause 17: The method of any one of Clauses 1-16, further comprising: executing the ML model to generate the predicted information associated with the UE; and refining the ML model using the feedback information.

Clause 18: A method for wireless communications by an apparatus at a first target network node, comprising: receiving a handover request associated with handing over a UE to a cell associated with the apparatus, the handover request comprising an ID of a source network node and predicted information associated with the UE, the predicted information generated by a machine learning (ML) model; and transmitting, to the source network node, an information update message comprising: feedback information comprising feedback on the predicted information, the feedback information associated with refining the ML model, and a first persistent ID assigned to the UE, wherein the first persistent ID remains invariant across different radio resource control (RRC) modes of the UE, wherein the different RRC modes comprise an idle mode, an inactive mode, and a connected mode.

Clause 19: The method of Clause 18, wherein the handover request further comprises the first persistent ID assigned to the UE.

Clause 20: The method of any one of Clauses 18-19, wherein the apparatus is configured with one or more measurement IDs, each of the one or more measurement IDs being associated with measurement information relating to the ML model.

Clause 21: The method of Clause 20, wherein the one or more measurement IDs are unique to the apparatus.

Clause 22: The method of any one of Clauses 20-21, wherein: the handover request further comprises at least one of the one or more measurement IDs, and the feedback information associated with the UE comprises the measurement information for the UE associated with the at least one of the one or more measurement IDs.

Clause 23: The method of any one of Clauses 18-22, wherein the predicted information comprises at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 24: The method of any one of Clauses 18-23, wherein the feedback on the predicted information comprises at least one of: trajectory feedback for the UE; predicted traffic feedback for the UE; predicted QoS feedback for the UE; predicted QoE feedback for the UE; predicted beam feedback for the UE.

Clause 25: The method of any one of Clauses 18-24, wherein: the first persistent ID is obtained using a second persistent ID previously assigned to the UE, and the information update message further comprises the second persistent ID previously assigned to the UE.

Clause 26: The method of any one of Clauses 18-25, wherein receiving the handover request further comprises receiving the handover request from the second target network node.

Clause 27: The method of Clause 26, further comprising transmitting, to the source network node, prior to transmitting the information update message, information indicating that the UE is operating in the connected mode with the apparatus.

Clause 28: The method of Clause 27, wherein the information indicating the UE is operating in the connected mode with the apparatus comprises, at least, the first persistent ID assigned to the UE.

Clause 29: The method of Clause 27, further comprising receiving, from the source network node, the predicted information associated with the UE, and the predicted information comprises at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 30: The method of Clause 27, wherein the apparatus is configured with one or more measurement IDs, each of the one or more measurement IDs being associated with measurement information relating to the ML model and unique to the apparatus.

Clause 31: The method of Clause 30, wherein the feedback information associated with the UE comprises the measurement information for the UE associated with the one or more measurement IDs.

Clause 32: The method of Clause 26, further comprising receiving, from a second UE, a RRC connection request requesting to re-establish or resume an RRC connection with the second UE, the RRC connection request comprising the ID of the source network node.

Clause 33: The method of Clause 32, wherein the RRC connection message further comprises an indication of when an inactivity of the second UE was detected by the second target network node.

Clause 34: The method of Clause 32, further comprising receiving, from an AMF, the ID of the source node and a secondary persistent ID assigned to the second UE.

Clause 35: The method of Clause 34, further comprising receiving, from the AMF, one or more predictions for the second UE, and the one or more predictions comprise at least one of: predicted trajectory information for the second UE; predicted traffic for the second UE; predicted QoS for the second UE; predicted QoE for the second UE; one or more predicted beams associated with one or more predicted cells for the second UE; or predicted beam trajectory for the second UE.

Clause 36: The method of Clause 32, further comprising: transmitting, to the second target network node previously having an RRC connection established with the apparatus, a request for context associated with the second UE; and receiving, from the second target network node, the context associated with the second UE, the context associated with the second UE comprising the ID of the source network node.

Clause 37: The method of Clause 36, wherein the context associated with the second UE further comprises second predicted information for the second UE, the second predicted information comprising at least one of: predicted trajectory information for the second UE; predicted traffic for the second UE; predicted QoS for the second UE; or predicted QoE for the second UE; one or more predicted beams associated with one or more predicted cells for the second UE; or predicted beam trajectory for the second UE.

Clause 38: The method of Clause 34, wherein: the apparatus is configured with one or more measurement IDs, each of the one or more measurement IDs being associated with measurement information relating to the ML model; and the context associated with the second UE further comprises the one or more measurement IDs.

Clause 39: The method of any one of Clauses 18-25, wherein receiving the handover request further comprises receiving the handover request from the source network node.

Clause 40: The method of Clause 39, further comprising: handing over the UE to the cell associated with the apparatus; and transmitting, to a second target network node, another handover message used to initiate a handover of the UE from the cell associated with the apparatus to another cell associated with the second target network node, the handover message comprising, at least, the ID of the source network node.

Clause 41: The method of any one of Clauses 39-40, further comprising detecting inactivity of the UE; and transmitting, to the UE, an RRC release message indicating that the UE is to transition from the connected mode to the idle mode or the inactive mode, the RRC release message comprising the ID of the source network node.

Clause 42: The method of Clause 41, wherein the RRC release message further comprises an indication of when inactivity of the UE was detected by the first target network node.

Clause 43: The method of any one of Clauses 41-42, wherein: the information update message further comprises information indicating that the UE has transitioned from a connected mode to an idle mode or an inactive mode.

Clause 44: The method of any one of Clauses 41-43, further comprising transmitting, to an AMF, the ID of the source network node.

Clause 45: The method of Clause 44, further comprising transmitting, to the AMF, one or more predictions for the UE, and the one or more predictions comprise at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 46: The method of Clause 41, further comprising: receiving, from a second target network node, a request for context associated with the UE; and transmitting, to the second target network node, the context associated with the UE, the context associated with the UE comprising the ID of the source network node.

Clause 47: The method of Clause 46, wherein the context associated with the UE further comprises one or more predictions for the UE, the one or more predictions comprising at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 48: The method of Clause 46, wherein: the second target network node is configured with one or more measurement IDs, each of the one or more measurement IDs being associated with measurement information relating to the ML model; and the context associated with the UE further comprises the one or more measurement IDs.

Clause 49: A method for wireless communications by an apparatus at a first target network node comprising: receiving a RRC connection request to re-establish or resume an RRC connection with a UE, the RRC connection request comprising an ID of a source network node configured to use a ML model to generate predicted information for the UE; re-establishing or resuming the RRC connection with the UE; and transmitting, to the source network node, an information update message comprising: feedback information comprising feedback on the predicted information, the feedback information associated with refining the ML model, and a first persistent ID assigned to the UE, wherein the first persistent ID remains invariant across different radio resource control (RRC) modes of the UE, wherein the different RRC modes comprise an idle mode, an inactive mode, and a connected mode.

Clause 50: The method of Clause 49, wherein the RRC connection request further comprises an indication of when an inactivity of the UE was detected by a second target network node.

Clause 51: The method of Clause 50, further comprising receiving, from an AMF, the ID of the source node and the first persistent ID assigned to the UE.

Clause 52: The method of Clause 51, further comprising receiving, from the AMF, the predicted information for the UE, and the predicted information comprising at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 53: The method of Clause 50, further comprising: transmitting, to the second target network node, a request for context associated with the UE; and receiving, from the second target network node, the context associated with the UE, the context associated with the UE comprising the ID of the source network node.

Clause 54: The method of Clause 53, wherein the context associated with the UE further comprises the predicted information for the UE, the predicted information comprising at least one of: predicted trajectory information for the UE; predicted traffic for the UE; predicted QoS for the UE; predicted QoE for the UE; one or more predicted beams associated with one or more predicted cells for the UE; or predicted beam trajectory for the UE.

Clause 55: The method of Clause 53, wherein: the apparatus is configured with one or more measurement IDs, each of the one or more measurement IDs being associated with measurement information relating to the ML model; and the context associated with the UE further comprises the one or more measurement IDs.

Clause 56: The method of Clause 55, wherein the one or more measurement IDs are unique to the apparatus.

Clause 57: A method for wireless communications by an apparatus at a UE comprising: receiving, from a first target network node communicating with the apparatus, an RRC release message indicating that the apparatus is to transition from a connected mode to an idle mode or an inactive mode, the RRC release message comprising an ID of a source network node configured to generate predicted information for the apparatus via a ML model; transitioning from the connected mode to the inactive mode or the idle mode in response to receiving the RRC release message; and transmitting, to a second target network node, an RRC connection request to re-establish or resume an RRC connection with the second target network node, the RRC connection request comprising the ID of the source network node.

Clause 58: The method of Clause 57, wherein the RRC release message and the RRC connection request each comprise an indication of when an inactivity of the apparatus was detected by the first target network node.

Clause 59: One or more apparatuses, comprising: one or more memories comprising executable instructions; and one or more processors configured to execute the executable instructions and cause the one or more apparatuses to perform a method in accordance with any one of clauses 1-58.

Clause 60: One or more apparatuses, comprising means for performing a method in accordance with any one of clauses 1-58.

Clause 61: One or more non-transitory computer-readable media comprising executable instructions that, when executed by one or more processors of one or more apparatuses, cause the one or more apparatuses to perform a method in accordance with any one of clauses 1-58.

Clause 62: One or more computer program products embodied on one or more computer-readable storage media comprising code for performing a method in accordance with any one of clauses 1-58.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications at a source network node, comprising:
one or more memories; and
one or more processors configured to cause the apparatus to:
transmit a handover request associated with handing over a user equipment (UE) from a first cell associated with the apparatus to a second cell associated with a first target network node, the handover request comprising an identifier (ID) of the apparatus and predicted information associated with the UE, the predicted information generated by a machine learning (ML) model; and
receive an information update message comprising:
feedback information comprising feedback on the predicted information, the feedback information associated with refining the ML model, and
a first persistent ID assigned to the UE, wherein the first persistent ID remains invariant across different radio resource control (RRC) modes of the UE, wherein the different RRC modes comprise an idle mode, an inactive mode, and a connected mode.

2. The apparatus of claim 1, wherein:
the one or more processors are further configured to cause the apparatus to receive the first persistent ID assigned to the UE from an access and mobility management function (AMF) prior to transmitting the handover request, and
the handover request further comprises the first persistent ID assigned to the UE.

3. The apparatus of claim 1, wherein the one or more processors are further configured to cause the apparatus to configure the first target network node with one or more measurement IDs, each of the one or more measurement IDs being associated with measurement information relating to the ML model.

4. The apparatus of claim 3, wherein:
the handover request further comprises at least one of the one or more measurement IDs, and
the feedback information associated with the UE comprises the measurement information for the UE associated with the at least one of the one or more measurement IDs

5. The apparatus of claim 1, wherein:
to transmit the handover request, the one or more processors are configured to cause the apparatus to transmit the handover request to the first target network node; and
to receive the information update message, the one or more processors are configured to cause the apparatus to receive the information update message from the first target network node.

6. The apparatus of claim 1, wherein:
to transmit the handover request, the one or more processors are configured to cause the apparatus to transmit the handover request to the first target network node; and
to receive the information update message, the one or more processors are configured to cause the apparatus to receive the information update message from a second target network node.

7. The apparatus of claim 6, wherein the one or more processors are further configured to cause the apparatus to:
receive information indicating that the UE is operating in the connected mode with the second target network node; and
configure the second target network node to provide the feedback information associated with the UE.

8. The apparatus of claim 7, wherein the information indicating the UE is operating in the connected mode with the second target network node comprises, at least, the first persistent ID assigned to the UE.

9. The apparatus of claim 1, wherein the one or more processors are further configured to cause the apparatus to:
receive a second persistent ID previously assigned to the UE from an access and mobility management function (AMF) prior to transmitting the handover request;
store the second persistent ID in the one or more memories of the apparatus;
receive the information update message further comprising the second persistent ID; and
store the first persistent ID assigned to the UE in the one or more memories in place of the second persistent ID.

10. The apparatus of claim 1, wherein the information update message further comprises information indicating that the UE is operating in the idle mode or the inactive mode.

11. The apparatus of claim 1, wherein the one or more processors are further configured to:
receive information indicating that the UE is operating in the connected mode with a second target network node; and
transmit the predicted information associated with the UE to the second target network node.

12. An apparatus configured for wireless communications at a first target network node, comprising:
one or more memories; and
one or more processors configured to cause the apparatus to:
receive a handover request associated with handing over a user equipment (UE) to a cell associated with the apparatus, the handover request comprising an identifier (ID) of a source network node and predicted information associated with the UE, the predicted information generated by a machine learning (ML) model; and
transmit, to the source network node, an information update message comprising:
feedback information comprising feedback on the predicted information, the feedback information associated with refining the ML, and
a first persistent ID assigned to the UE, wherein the first persistent ID remains invariant across different radio resource control (RRC) modes of the UE, wherein the different RRC modes comprise an idle mode, an inactive mode, and a connected mode.

13. The apparatus of claim 12, wherein the handover request further comprises the first persistent ID assigned to the UE.

14. The apparatus of claim 12, wherein the apparatus is configured with one or more measurement IDs, each of the one or more measurement IDs being associated with measurement information relating to the ML model.

15. The apparatus of claim 14, wherein:
the handover request further comprises at least one of the one or more measurement IDs, and
the feedback information associated with the UE comprises the measurement information for the UE associated with the at least one of the one or more measurement IDs.

16. The apparatus of claim 12, wherein:
the one or more processors are further configured to obtain the first persistent ID using a second persistent ID previously assigned to the UE, and
the information update message further comprises the second persistent ID previously assigned to the UE.

17. The apparatus of claim 12, wherein, to receive the handover request, the one or more processors are configured to cause the apparatus to receive the handover request from a second target network node.

18. The apparatus of claim 17, wherein:
the one or more processors are further configured to, prior to transmitting the information update message, transmit, to the source network node, information indicating that the UE is operating in the connected mode with the apparatus.

19. The apparatus of claim 17, wherein the one or more processors are further configured to:
receive, from a second UE, a RRC connection request requesting to re-establish or resume an RRC connection with the second UE, the RRC connection request comprising the ID of the source network node; and
re-establish or resume the RRC connection with the second UE in response to receiving the RRC connection request.

20. The apparatus of claim 19, wherein the RRC connection request further comprises an indication of when an inactivity of the second UE was detected by the second target network node.

21. The apparatus of claim 19, wherein the one or more processors are further configured to receive, from an access and mobility management function (AMF), the ID of the source network node and a secondary persistent ID assigned to the second UE.

22. The apparatus of claim 19, wherein the one or more processors are further configured to:
transmit, to the second target network node previously having an RRC connection established with the second UE, a request for context associated with the second UE, and
receive, from the second target network node, the context associated with the second UE,
the context associated with the second UE comprising the ID of the source network node.

23. The apparatus of claim 12, wherein, to receive the handover request, the one or more processors are configured to cause the apparatus to receive the handover request from the source network node.

24. The apparatus of claim 23, wherein the one or more processors are configured to cause the apparatus to:
hand over the UE to the cell associated with the apparatus; and
transmit, to a second target network node, another handover message used to initiate a handover of the UE from the cell associated with the apparatus to another cell associated with the second target network node, the handover message comprising, at least, the ID of the source network node.

25. The apparatus of claim 23, wherein the one or more processors are further configured to:
detect inactivity of the UE; and
transmit, to the UE, an RRC release message indicating that the UE is to transition from the connected mode to the idle mode or the inactive mode, the RRC release message comprising the ID of the source network node.

26. The apparatus of claim 25, wherein the information update message further comprises information indicating that the UE has transitioned from the connected mode to the idle mode or the inactive mode.

27. The apparatus of claim 25, wherein the one or more processors are further configured to:
receive, from a second target network node, a request for context associated with the UE, and
transmit, to the second target network node, the context associated with the UE,
the context associated with the UE comprising the ID of the source network node.

28. An apparatus configured for wireless communications at a user equipment (UE), comprising:
one or more memories; and
one or more processors configured to cause the apparatus to:
receive, from a first target network node communicating with the apparatus, an RRC release message indicating that the apparatus is to transition from a connected mode to an idle mode or an inactive mode, the RRC release message comprising an identifier (ID) of a source network node configured to generate predicted information for the apparatus via a machine learning (ML) model;
transition from the connected mode to the inactive mode or the idle mode in response to receiving the RRC release message; and
transmit, to a second target network node, an RRC connection request requesting to re-establish or resume a RRC connection with the second target network node, the RRC connection request comprising the ID of the source network node.

29. The apparatus of claim 28, wherein the RRC release message and the RRC connection request each comprise an indication of when an inactivity of the apparatus was detected by the first target network node.

30. A method for wireless communications by an apparatus at a source network node, comprising:
transmitting a handover request associated with handing over a user equipment (UE) from a first cell associated with the apparatus to a second cell associated with a first target network node, the handover request comprising an identifier (ID) of the apparatus and predicted information associated with the UE, the predicted information generated by a machine learning (ML) model; and
receiving an information update message comprising:
feedback information comprising feedback on the predicted information, the feedback information associated with refining the ML model, and
a first persistent ID assigned to the UE, wherein the first persistent ID remains invariant across different radio resource control (RRC) modes of the UE, wherein the different RRC modes comprise an idle mode, an inactive mode, and a connected mode.
